(19) United States
(12) Patent Application Publication
(10) Pub. No.: US 2026/0244920 A1
(43) Pub. Date: Aug. 20, 2026

(54) INFORMATION PROCESSING APPARATUS, DATA GENERATION METHOD, AND PROGRAM

(71) Applicant: Sony Semiconductor Solutions Corporation, Atsugi-shi, Kanagawa (JP)

(72) Inventors: Namiki HAGIO, Kanagawa (JP); Tomoki UEDA, Kanagawa (JP)

(73) Assignee: Sony Semiconductor Solutions Corporation, Atsugi-shi, Kanagawa (JP)

(21) Appl. No.: 19/164,585

(22) PCT Filed: Mar. 1, 2024
(86) PCT No.: PCT/JP2024/007728

§ 371 Date: Sep. 12, 2025

(30) Foreign Application Priority Data
Mar. 28, 2023 (JP) 2023-052110

(51) Int. Cl. G06N 3/08; G06F 17/18; G06N 3/0455

(52) U.S. Cl. CPC G06N 3/08; G06F 17/18; G06N 3/0455

(57) ABSTRACT

The present technology relates to an information processing apparatus, a data generation method, and a program capable of efficiently generating a large number of data.

A generation probability distribution used for generation of a latent variable for generating output data in a generation model of the output data that outputs the output data with respect to an input of the input data is generated as the output data, on the basis of a first probability distribution for generating data obtained by restoring the input data, and a second probability distribution along learning data used for learning of the generation mode, the latent variable is generated on the basis of the generation probability distribution. The generation model generates the output data on the basis of the latent variable. The present technology can be applied to, for example, a data generation device that generates data such as a face image.

### TECHNICAL FIELD

The present technology relates to an information processing apparatus, a data generation method, and a program, and particularly relates to, for example, an information processing apparatus, a data generation method, and a program capable of efficiently generating a large number of data.

### BACKGROUND ART

For example, as learning data used for learning of an artificial intelligence (AI) model as a discrimination model (discriminator) for discriminating a face, (data of) a face image in which faces having various attribute values of attributes such as gender, age, and race appear may be requested.

Learning of the AI model as the identification model requires a large number of images at the level of tens of thousands of sheets as learning data. However, it is difficult to collect such a large number of images as images suitable for a desired use case (situation). Furthermore, in recent years, laws and regulations on privacy have become stricter, and it is difficult to collect a large number of images as learning data by clearing such laws and regulations.

Therefore, a technology of generating a face (composite) image to which a feature of a secondary attribute (value) is given while leaving a main feature of an original image on an image basis has been proposed (see, for example, Patent Document 1).

In the technique described in Patent Document 1, an image most similar to an input image is determined as a selected image from among images belonging to a designated category among images classified into a plurality of categories stored in a database, and an intermediate image between the selected image and the input image is generated. The intermediate image is generated by combining the selected image and the input image.

In the technique described in Patent Document 1, it is difficult to generate an intermediate image beyond the range of images classified into categories. Furthermore, the accuracy of composition of the intermediate image changes depending on the similarity of the selected image to the input image.

### CITATION LIST

### Patent Document

Patent Document 1: Japanese Patent No. 4721052

### SUMMARY OF THE INVENTION

### Problems to be Solved by the Invention

As a method of generating a large number of face images, for example, there is a method of generating face images of various attribute values using an AI model such as a variational autoencoder (VAE) or a style generative adversarial network (StyleGAN) as a face synthesis model (generation model). Note that, among the VAEs, particularly, a very deep VAE (VDVAE) is described in, for example, CHILD, Rewon. Very deep VAEs generalize autoregressive models and can outperform them on images. arXiv preprint arXiv: 2011.10650, 2020. StyleGAN is described in, for example, KARRAS, Tero; LAINE, Samuli; AILA, Timo. A style-based generator architecture for generic adversarial networks. In: Proceedings of the IEEE/CVF conference on computer vision and pattern recognition. 2019. p. 4401-4410.

The face image output by the AI model as the face synthesis model depends on learning data used for learning of the AI model. Therefore, in a case where there is no or almost no image along the target image (image having an attribute value requested by user, which is desired to be generated) with (the range of) the attribute value to be the target, that is, there is no or almost no image with the attribute value similar to the target image in the (face) image as the learning data, it is difficult to efficiently generate the target image in the AI model learned using such learning data.

For example, in the public face image data set, there is an age group bias such as a small number of elderly people in their sixties or older and young people in their teens or younger, a race bias such as a small number of Japanese, and the like. In the AI model using such a data set as learning data, even if 1000 or more images are generated, only about several tens of face images of young people, elderly people, and Japanese are generated, and in a case where the target image is a face image of young people, elderly people, or Japanese, it is difficult to efficiently generate a large number of target images.

In this regard, the similarity applies not only to the image but also to the case of generating other data.

The present technology has been made in view of such a situation, and makes it possible to efficiently generate a large number of data.

### Solutions to Problems

An information processing apparatus or a program of the present technology is an information processing apparatus including a control unit or a program for causing a computer to function as such an information processing apparatus including the control unit that: generates a generation probability distribution used for generation of a latent variable for generating output data in a generation model of the output data that outputs the output data with respect to an input of input data, as the output data, on the basis of a first probability distribution for generating data obtained by restoring the input data, and a second probability distribution along learning data used for learning of the generation model; generates the latent variable on the basis of the generation probability distribution; and causes the generation model to generate the output data on the basis of the latent variable.

A data generation method of the present technology is a data generation method including: generating a generation probability distribution used for generation of a latent variable for generating output data in a generation model of the output data that outputs the output data with respect to an input of input data, as the output data, on the basis of a first probability distribution for generating data obtained by restoring the input data, and a second probability distribution along learning data used for learning of the generation model; generating the latent variable on the basis of the generation probability distribution; and generating, by the generation model, the output data on the basis of the latent variable.

In the information processing apparatus, the data generation method, and the program of the present technology, a generation probability distribution used for generation of a latent variable for generating output data in a generation model of the output data that outputs the output data with respect to an input of the input data is generated as the output data, on the basis of a first probability distribution for generating data obtained by restoring the input data, and a second probability distribution along learning data used for learning of the generation mode. Then, the latent variable is generated on the basis of the generation probability distribution, and the output data is generated on the basis of the latent variable in the generation model.

Note that the information processing apparatus may be an independent apparatus or may be an internal block constituting an apparatus.

Further, the program may be provided by being transmitted through a transmission medium or being recorded in a recording medium.

### BRIEF DESCRIPTION OF DRAWINGS

FIG. 1 is a block diagram illustrating a configuration example of an embodiment of a data generation device to which the present technology is applied.

FIG. 2 is a block diagram illustrating a configuration example of an encoder 21 and a decoder 24.

FIG. 3 is a block diagram illustrating a configuration example of a residual block 31.

FIG. 4 is a block diagram illustrating a configuration example of a topdown block 41.

FIG. 5 is a diagram illustrating an outline of first generation control of an output image.

FIG. 6 is a diagram illustrating an example of generation of a generation probability distribution q [new] in the first generation control.

FIG. 7 is a diagram illustrating an example of setting a weight α by qualitative evaluation.

FIG. 8 is a diagram illustrating an example of setting of an application layer of the generation probability distribution q [new] by qualitative evaluation.

FIG. 9 is a diagram illustrating an example of an output image generated by a decoder 24 on which the first generation control has been performed.

FIG. 10 is a diagram illustrating another example of the output image generated by the decoder 24 on which the first generation control has been performed.

FIG. 11 is a diagram illustrating an example of a distribution of feature amounts of an input image and an output image generated by the first generation control using the input image.

FIG. 12 is a flowchart illustrating an example of processing of the first generation control by an attribute/ID control unit 23.

FIG. 13 is a diagram illustrating an outline of second generation control of the output image.

FIG. 14 is a diagram illustrating an example of conversion of a latent variable z in the second generation control.

FIG. 15 is a diagram illustrating an example of attributes to which contribution vectors β·nv contribute.

FIG. 16 is a flowchart illustrating an example of processing of generating a normal vector nv by an attribute/ID control unit 23.

FIG. 17 is a diagram illustrating an example of setting a threshold of separation accuracy by qualitative evaluation.

FIG. 18 is a diagram illustrating an example of an output image generated by the decoder 24 on which the second generation control has been performed.

FIG. 19 is a diagram illustrating another example of the output image generated by the decoder 24 on which the second generation control has been performed.

FIG. 20 is a flowchart illustrating an example of processing of second generation control by the attribute/ID control unit 23.

FIG. 21 is a flowchart illustrating an example of processing of normalizing a converted latent variable zt performed in step S34.

FIG. 22 is a diagram illustrating an example of an output image in a case where normalization of the converted latent variable zt is performed and an example of an output image in a case where the normalization is not performed.

FIG. 23 is a diagram illustrating an example of a UI generated by a UI processing unit 26.

FIG. 24 is a diagram illustrating another example of the UI generated by the UI processing unit 26.

FIG. 25 is a block diagram illustrating a configuration example of an embodiment of a computer to which the present technology is applied.

### MODE FOR CARRYING OUT THE INVENTION

### One Embodiment of Data Generation Device to Which Present Technology is Applied

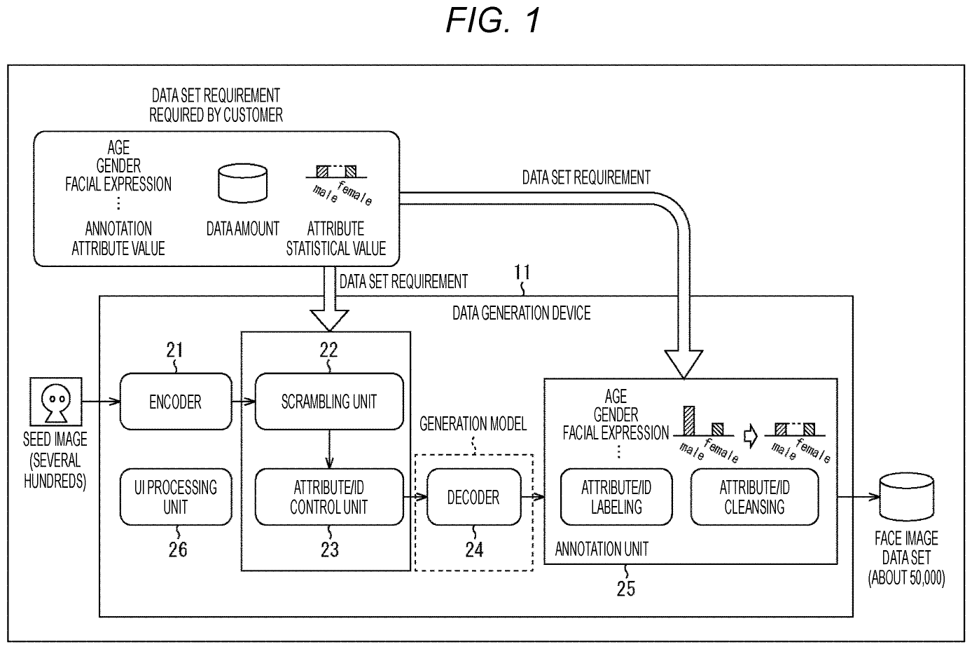

FIG. 1 is a block diagram illustrating a configuration example of an embodiment of a data generation device to which the present technology is applied.

A data generation device 11 generates and outputs an output image as output data in response to an input of an input image as input data.

In the data generation device 11, for example, a real face image obtained by photographing an actual face or a fictitious face image in which a fictitious face generated by an arbitrary generation model appears is input as a seed image to be a seed of image generation, and the seed image is input as an input image. The data generation device 11 generates, as an output image, a fictitious face image having an individual (person) and an attribute (attribute value) different from those of the face appearing in the seed image as the input image. Therefore, according to the data generation device 11, it is possible to obtain an output image serving as a face image data set in which privacy is protected and personal information is free.

The data generation device 11 controls (operates) a generation parameter obtained from a seed image (input image) prepared in advance, and generates a large number of various images such as an image in which the attribute value of the desired attribute has a desired value or various values from a small number of seed images. Therefore, an image as a large number of data can be efficiently generated, and a large number of images can be enlarged. Note that the image in which the attribute value of the desired attribute has a desired value is, for example, an image in which (the attribute value of) race as the attribute is Japanese. The image in which the attribute value of the desired attribute has various values is, for example, an image in which (the attribute value of) the age as the attribute ranges from the young people to the elderly people. In addition, the control of the generation parameter includes processing in which the generation parameter is controlled as a result in addition to the case where the generation parameter is directly controlled.

The generation parameter potentially includes features of the face such as human eyes, skin color, and hairstyle, particularly features of the appearance of the face. By providing the generation parameter to the generation model, a face image can be obtained as an output of the generation model. The generation parameter is also referred to as a latent variable.

The data generation device 11 performs labeling and cleansing on a large number of face images obtained by controlling a latent variable as a generation parameter, thereby generating a face image data set including all or a part of the large number of face images.

In the labeling, an attribute value of each attribute of (a face appearing in) the face image and a face ID (identification) are assigned to the face image. In labeling, annotation for automatically assigning an attribute value and a face ID is performed without manual intervention.

For the face image, the attribute is, for example, an item related to the feature of the face (the feature of the appearance of the face) appearing in the face image, such as age, gender, facial expression, eye shape, hair color, and race. The face ID is an ID for identifying an individual (person) whose face appears in the face image. The same face ID is assigned to a plurality of face images identified as the same person, and different face IDs are assigned to a plurality of face images identified as different persons.

In the cleansing, processing of setting a statistical value (distribution) of attribute values of attributes of face images constituting the face image data set, the number of face IDs, resolution of face images, and the number of face images (the number of data (the number of pieces)) constituting the face image data set to desired values is performed. For example, face image thinning, that is, partial face image deletion, downsampling or upsampling of a face image, or the like is performed.

By performing enlargement of the face image (seed image), labeling, and cleansing, it is possible to realize the equality that reduces the statistical bias such as the attribute of the face image data set. Furthermore, it is possible to construct a face image data set according to the number of data required by a customer such as an AI developer, resolution, an attribute (value), and a statistical value at low cost.

In the enlargement of the face image, it is possible to generate a wide variety of face images having various attributes (attribute values) and face IDs by controlling the latent variable instead of editing the face image itself on an image basis. In addition, by changing (controlling) the latent variable in a direction in which the attribute value of the desired attribute of the face image changes in the latent space of the latent variable, it is possible to easily generate the face image having the attribute value that tends to be insufficient when the face is actually photographed or the face image along the attribute value or the statistical value desired by the customer such as the AI developer. Therefore, the construction cost of the desired face image data set can be suppressed low.

In the data generation device 11, a fictitious face image, a real face image provided from a customer, or the like can be used as the seed image (input image) used for the enlargement.

Requirements (hereinafter, also referred to as a data set requirement) of the face image data set requested by the customer, for example, the number of data, the number of persons (the number of face IDs), resolution, attribute, attribute statistical value (distribution of attribute values of each attribute), and the like can be set by operating the data generation device 11. In addition, the data set requirement can be set in the data generation device 11, for example, from a file storing the data set requirement.

The file of the finally obtained face image data set can include a face image, an index file in which a face ID and an attribute label are associated with the face image, a thumbnail (image) of the face image, and an attribute statistical value data file indicating an attribute statistical value of each attribute.

In the data generation device 11, clustering of generated face images (output images) is performed by an identifier that identifies a person or an attribute, so that labeling can be performed, a face ID and an attribute value can be assigned, and an attribute statistical value (statistic amount of the attribute value) can be calculated. Further, cleansing can be performed so that the attribute statistical value of the output image is equal to the attribute statistical value requested by the customer as a data set requirement, and a final face image data set can be generated.

The data generation device 11 includes an encoder 21, a scrambling unit 22, an attribute/ID control unit 23, a decoder 24, an annotation unit 25, and a user interface (UI) processing unit 26. The seed image as the input image and the data set requirement are input to the data generation device 11, and the data generation device 11 generates the face image data set on the basis of the input seed image and data set requirement. For example, the data generation device 11 can construct a face image data set including about 50,000 face images from about several hundred seed images.

A plurality of seed images as input images prepared in advance is supplied to the encoder 21. The encoder 21 is, for example, an autoencoder (AE), and extracts a feature amount from the seed image and supplies the feature amount to the scrambling unit 22.

The scrambling unit 22 scrambles the feature amount of the seed image from the encoder 21, and supplies the scrambled feature amount to the attribute/ID control unit 23. The scrambling is processing of making the feature amount of the seed image non-restorable, and in the scrambling, for example, arbitrary random noise, a feature amount extracted from an image prepared in advance separately from the seed image, or the like is added to the feature amount of the seed image. By scrambling, it is possible to enhance protection of privacy of a real person in a case where the real person appears in the seed image.

The scrambling of the feature amount in the scrambling unit 22 can be performed as necessary. Furthermore, the scrambling unit 22 can be supplied with the data set requirement required by the customer. As described above, the data set requirement is, for example, the number of data of face images constituting the face image data set, resolution of the face image, attributes such as age to be labeled, attribute statistical values indicating the distribution of attribute values of each attribute, and the like, which are specified by the customer. The scrambling unit 22 can scramble the feature amount on the basis of the data set requirement.

The attribute/ID control unit 23 performs generation control of generation of an output image by the decoder 24 that generates a face image as an output image on the basis of information obtained from the feature amount of the seed image from the scrambling unit 22 or the like.

For example, in the generation control, the attribute/ID control unit 23 generates latent variables of a large number of output images in which faces that can be identified by other persons appear while maintaining (the attribute value of) the attribute of the seed image on the basis of information obtained from the feature amount of the seed image or the like (for example, a probability distribution q to be described later and the like). A large number of output images in which faces that can be identified by other persons appear means images to which different face IDs can be assigned.

Furthermore, for example, in the generation control, the attribute/ID control unit 23 generates latent variables of a large number of output images in which (the attribute value of) a specific attribute of the species image, for example, age (apparent age) is changed on the basis of information (for example, a contribution vector and the like to be described later) obtained from the feature amount or the like of the species image.

Then, in the generation control, the attribute/ID control unit 23 causes the decoder 24 to generate the output image on the basis of the latent variable of each output image.

A data set requirement can be supplied to the attribute/ID control unit 23. The attribute/ID control unit 23 can perform generation control on the basis of the data set requirement.

The decoder 24 is a generation model of an output image that outputs an output image (output data) in response to an input of an input image (input data) to the encoder 21, and is, for example, a decoder of an AE. The decoder 24 can generate and output an output image based on the latent variable generated by the attribute/ID control unit 23 according to the generation control of the attribute/ID control unit 23. The output image output from the decoder 24 is supplied to the annotation unit 25. Note that the decoder 24 as a generation model can generate an output image regardless of the input of the input image to the encoder 21. In this case, the output image generated by the decoder 24 is an image in a range along the learning data used for learning by the decoder 24.

The data set requirement is supplied to the annotation unit 25. The annotation unit 25 generates (constructs) a face image data set satisfying the data set requirement on the basis of the data set requirement and the output image from the decoder 24, and outputs the face image data set to a subsequent stage of a recording unit (not illustrated) or the like.

That is, the annotation unit 25 labels and cleanses (cleans) the face image data set (face image) with respect to the attribute and the face ID, and generates a final face image data set satisfying the data set requirement.

In the annotation unit 25, for example, by using an existing arbitrary clustering method, similarity calculation method, discriminator obtained by learning in advance, or the like, labeling and cleansing can be performed without requiring an operation of a user or the like, that is, without requiring manual operation. The user is a user who uses the data generation device 11, and includes an operator, a customer, and the like of the data generation device 11.

Cleansing is bias removal processing for removing statistical data bias such as attributes (values) of a plurality of output images. For example, in the cleansing, some output images constituting the face image data set are deleted (removed) such that the number of data, the attribute statistical value, and the number of people are set as the data set requirements, and the number of data, the attribute statistical value, and the number of persons are adjusted. In the adjustment of the number of persons, output images to which the same face ID is assigned are deleted.

The UI processing unit 26 functions as a UI generation unit that generates an image as a user interface (GUI) including information to be provided to the user, buttons to be operated by the user, and the like as necessary, and displays the UI on a display unit (not illustrated) to present the UI to the user. Furthermore, the UI processing unit 26 performs various settings and controls necessary blocks constituting the data generation device 11 according to an operation of a user on the UI.

Note that, in a case where the data generation device 11 is configured as a server-client system, for example, a server can function as the data generation device 11. In this case, the UI processing unit 26 can transmit the UI to the client for display.

### Configuration Examples of Encoder 21 and Decoder 24

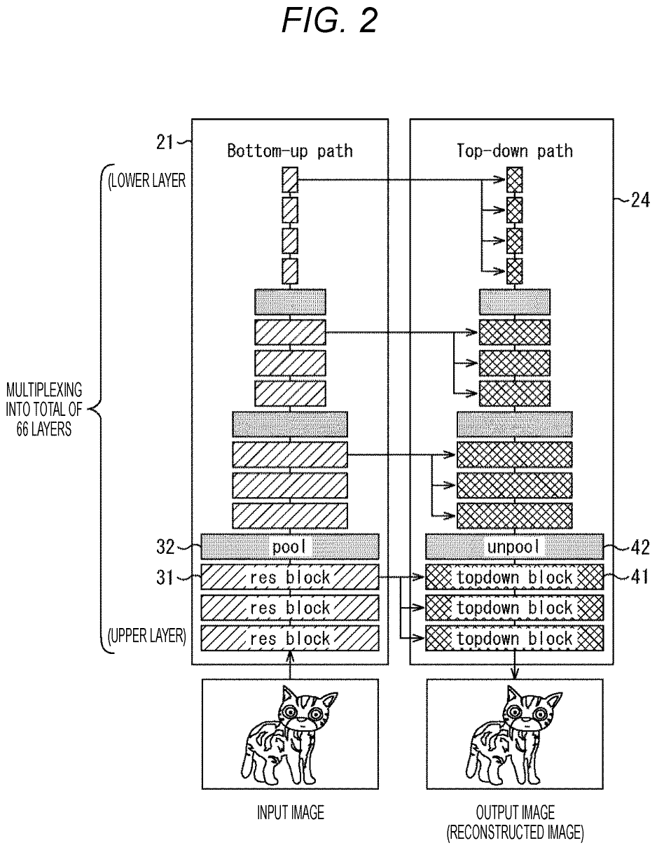

FIG. 2 is a block diagram illustrating a configuration example of the encoder 21 and the decoder 24.

That is, FIG. 2 illustrates a configuration example of the encoder 21 and the decoder 24 in a case where (a decoder of) a very deep VAE (VDVAE) is adopted as a generation model for generating an output image.

In FIG. 2, the encoder 21 and the decoder 24 are an encoder and a decoder of the VDVAE, respectively. Note that FIG. 2 and FIGS. 3 and 4 to be described later are citations from CHILD, Rewon. Very deep VAEs generalize autoregressive models and can outperform them on images. arXiv preprint arXiv: 2011.10650, 2020.

The encoder 21 includes 66 layers of residual blocks (res blocks) 31 as a plurality of layers, and a pooling layer (pool) 32 inserted for each of several residual blocks 31. In the encoder 21, an input image is input to the lowest residual block 31 in the drawing, and data flows along a path extending from bottom to up (bottom-up path).

The residual block 31 receives an output of the immediately below residual block 31 or the pooling layer 32 as an input, extracts (generates) a feature amount (activations) of the input image from the input, and outputs the feature amount (activations) to the immediately above residual block 31 or the pooling layer 32. Note that the lowermost residual block 31 extracts the feature amount of the input image from the input image.

The pooling layer 32 performs pooling of the output of the immediately below residual block 31 (the feature amount of the input image) and outputs the same to the immediately above residual block 31.

The decoder 24 includes 66 layers of topdown block (topdown block) 41 that is the same as the encoder 21, and an unpooling layer (unpool) 42 inserted for each of several topdown blocks 41. The unpooling layer 42 is inserted at a position corresponding to the pooling layer 32 of the encoder 21. In the decoder 24, data flows along a path extending from top to down (top-down path).

In the encoder 21, among the residual blocks 31, the residual block 31 immediately below the pooling layer 32 and the uppermost residual block 31 also output the feature amount of the input image to the topdown block 41 from the topdown block 41 at the position corresponding to the residual block 31 to the topdown block 41 immediately above the next unpooling layer 42 in the downward direction.

The topdown block 41 uses the output of the immediately above topdown block 41 or the unpooling layer 42 as an input and uses the feature amount of the input image output by the residual block 31 as an input as necessary, generates the feature amount (feature) of the output image from the input, and outputs the feature amount to the immediately below topdown block 41 or the unpooling layer 42. Note that the lowermost topdown block 41 outputs an output image.

The unpooling layer 42 performs unpooling of the output (the feature amount of the output image) of the immediately above topdown block 41, and outputs the unpooling of the output to the immediately below topdown block 41.

In the topdown block 41, in a case where the feature amount of the output image is generated using both the output of the immediately above topdown block 41 or the unpooling layer 42 and the feature amount of the input image output by the residual block 31 as inputs, the output image is a reconstructed image obtained by restoring the input image.

Here, in FIG. 2, illustration of some of the 66 layers of residual block 31 and the topdown block 41 is omitted. In addition, regarding the layers of the residual block 31 and the topdown block 41, in the drawing, the lower side is an upper layer, and the upper side is a lower layer.

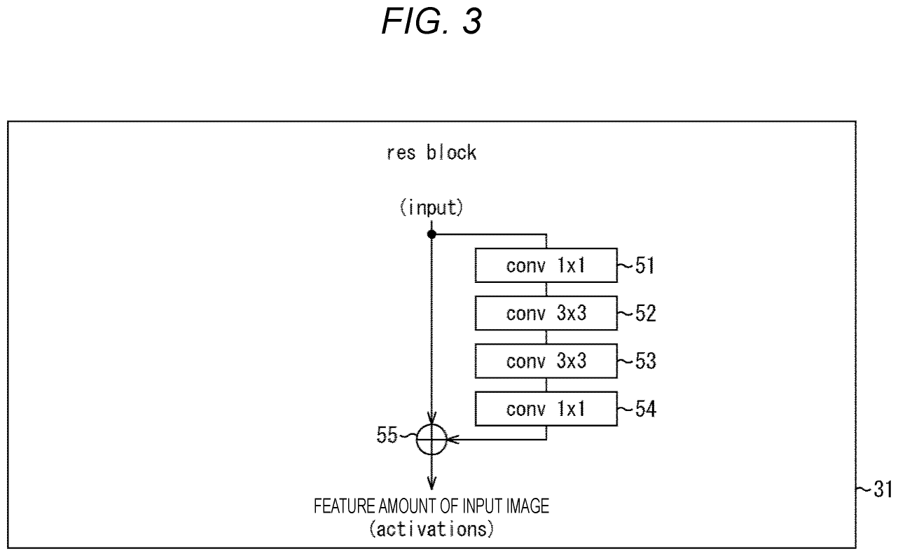

FIG. 3 is a block diagram illustrating a configuration example of the residual block 31.

The residual block 31 includes convolution layers (conv) 51 to 54 and an addition unit 55.

The input image, the output of the immediately preceding (upper layer) residual block 31, or the output of the immediately preceding pooling layer 32 is supplied to the convolution layer 51 as an input (input) to the residual block 31. The convolution layer 51 performs 1×1 convolution (kernel application) on the input to the residual block 31, and outputs the result to the convolution layer 52. The convolution layer 52 performs 3×3 convolution on the output of the convolution layer 51 and outputs the result to the convolution layer 53. The convolution layer 53 performs 3×3 convolution on the output of the convolution layer 52, and outputs the result to the convolution layer 54. The convolution layer 54 performs 1×1 convolution on the output of the convolution layer 53, and outputs the result to the addition unit 55.

In addition to the output of the convolution layer 54, an input to the residual block 31 is supplied to the addition unit 55. The addition unit 55 adds the input to the residual block 31 and the output of the convolution layer 54, and outputs the addition result as the feature amount (activations) of the input image.

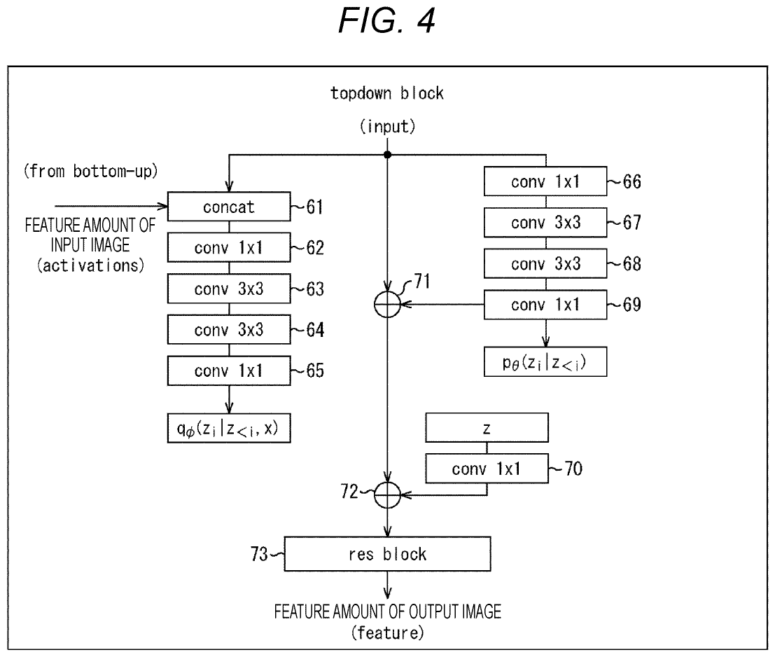

FIG. 4 is a block diagram illustrating a configuration example of the topdown block 41.

The topdown block 41 includes a concatenating portion (concat) 61, convolution layers (conv) 62 to 70, addition units 71 and 72, and a residual block (res block) 73.

A fixed value, an output of the immediately preceding (lower layer) topdown block 41, or an output of the immediately preceding pooling layer 42 is supplied to the concatenating portion 61 as an input (input) to the topdown block 41. Furthermore, the concatenating portion 61 is supplied with feature values (activations) of the input image output from the residual block 31 of the encoder 21. The concatenating portion 61 concatenates the input to the topdown block 41 and the feature amount of the input image output from the residual block 31, and outputs the result to the convolution layer 62.

The convolution layer 62 performs 1×1 convolution on the output of the concatenating portion 61, and outputs the result to the convolution layer 63. The convolution layer 63 performs 3×3 convolution on the output of the convolution layer 62, and outputs the result to the convolution layer 64. The convolution layer 64 performs 3×3 convolution on the output of the convolution layer 63, and outputs the result to the convolution layer 65. The convolution layer 65 performs 1×1 convolution on the output of the convolution layer 64, and outputs the result.

Here, in the topdown block 41, a parameter that defines a predetermined probability distribution (first probability distribution) q is generated on the basis of the output of the convolution layer 65.

The probability distribution q is a probability distribution of the latent variable z for generating an image (data) obtained by restoring the input image (input data) as the output image (output data). An arbitrary probability distribution can be adopted as the probability distribution q. For example, in a case where a normal distribution is adopted as the probability distribution q, parameters that define the probability distribution q are an average value and a standard deviation (or variance).

An input to the topdown block 41 is supplied to the convolution layer 66. The convolution layer 66 performs 1×1 convolution on the input to the topdown block 41, and outputs the result to the convolution layer 67. The convolution layer 67 performs 3×3 convolution on the output of the convolution layer 66, and outputs the result to the convolution layer 68. The convolution layer 68 performs 3×3 convolution on the output of the convolution layer 67, and outputs the result to the convolution layer 69. The convolution layer 69 performs 1×1 convolution on the output of the convolution layer 68, and outputs the result to the addition unit 71.

Here, in the topdown block 41, a parameter that defines a predetermined probability distribution (second probability distribution) p is generated on the basis of the output of the convolution layer 69.

The probability distribution p is a probability distribution of the latent variable z along the learning data used for learning by the decoder 24 (and the encoder 21) as a generation model (a probability distribution followed by the latent variable z of the learning data). An arbitrary probability distribution can be adopted as the probability distribution p. For example, in a case where a normal distribution is adopted as the probability distribution p, parameters that define the probability distribution p are an average value and a standard deviation.

The latent variable z is supplied to the convolution layer 70. In the VDVAE, in a case where an image obtained by restoring the input image is generated as the output image, the topdown block 41 samples the latent variable z on the basis of the probability distribution q and supplies the latent variable z to the convolution layer 70. On the other hand, in a case where a random image is generated in a range along the learning data as the output image, the topdown block 41 samples the latent variable z on the basis of the probability distribution p and supplies the latent variable z to the convolution layer 70.

The convolution layer 70 performs 1×1 convolution on the latent variable z, and outputs the result to the addition unit 72.

In addition to the output of the convolution layer 69, an input to the topdown block 41 is supplied to the addition unit 71. The addition unit 71 adds the output of the convolution layer 69 and the input to the topdown block 41, and outputs the result to the addition unit 72. The addition unit 72 adds the output of the addition unit 71 and the output of the convolution layer 70, and supplies the result to the residual block 73.

The residual block 73 is configured similarly to the residual block 31 in FIG. 3. The residual block 73 performs processing similar to that of the residual block 31 using the output of the addition unit 72 as an input to the residual block 73, and outputs the processing result as a feature amount (feature) of the output image.

The attribute/ID control unit 23 can perform one or both of a first generation control and a second generation control as generation control of the output image by the decoder 24 configured as described above. Hereinafter, the first generation control and the second generation control will be described.

### First Generation Control

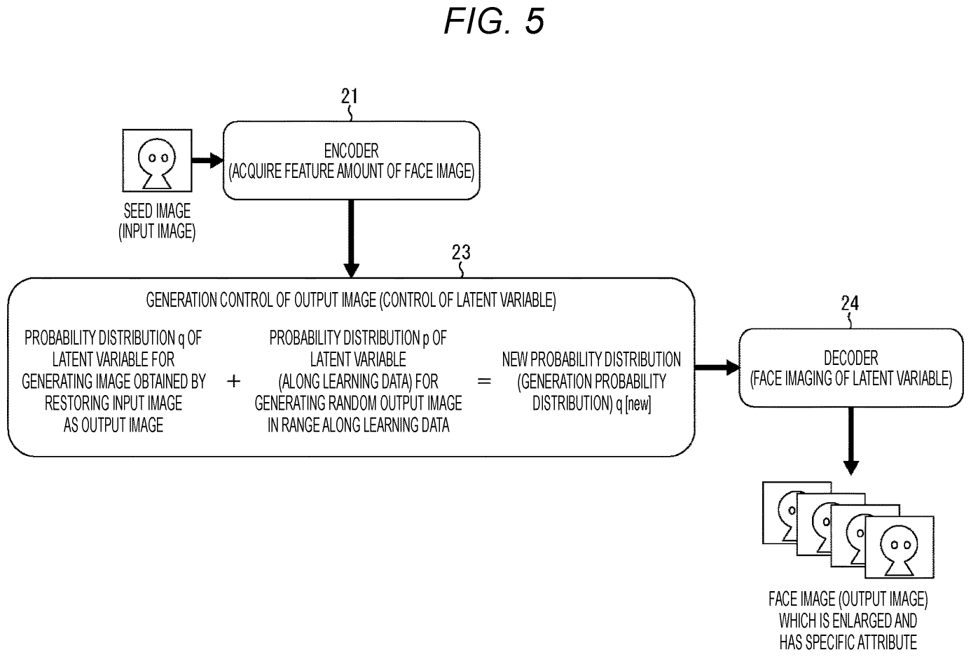

FIG. 5 is a diagram illustrating an outline of the first generation control of the output image.

In the first generation control, the attribute/ID control unit 23 generates a generation probability distribution q [new] as a new probability distribution on the basis of the probability distributions q and p. Then, the attribute/ID control unit 23 generates the latent variable z for generating the output image on the basis of the generation probability distribution q [new], and causes the decoder 24 to generate the output image on the basis of the latent variable z (perform face imaging of the latent variable z).

Here, as described with reference to FIG. 4, the probability distribution q is information obtained from the feature amount (activations) of the input image obtained by the encoder 21 and the feature amount (feature) of the output image obtained by the decoder 24. The probability distribution p is information obtained from the feature amount (feature) of the output image obtained by the decoder 24.

As described above, in the first generation control, the output image is generated on the basis of the latent variable z generated on the basis of the generation probability distribution q [new] generated on the basis of the probability distributions q and p. As a result, it is possible to efficiently generate, from a small number of input images (seed images), a large number of output images in which faces that maintain the attributes of the input images appear and can be identified as other persons and that are difficult to generate only by using the probability distribution q or p.

Furthermore, since the output image is generated on the basis of the latent variable z instead of the image-based processing such as editing and composition of the input image, an image showing a natural face can be generated as the output image.

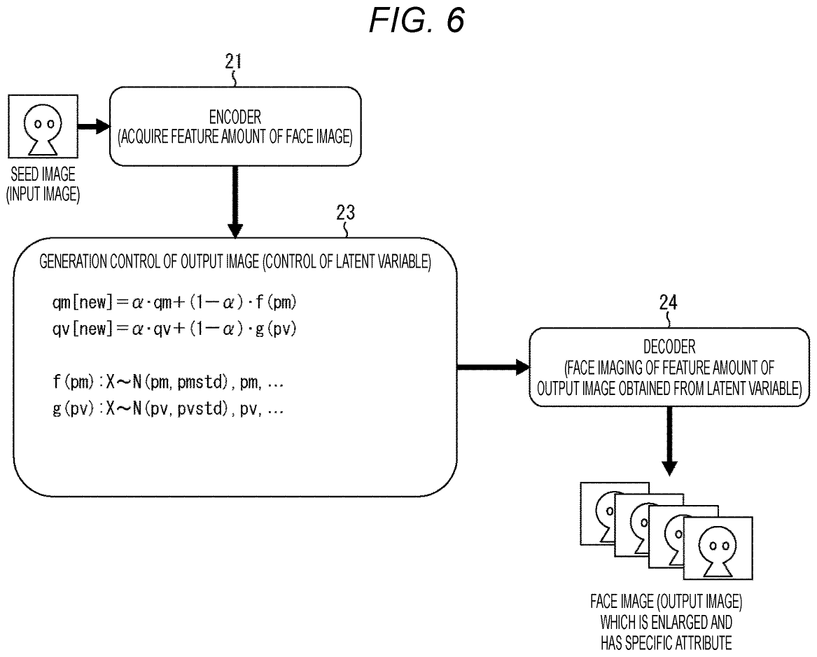

FIG. 6 is a diagram illustrating an example of generation of the generation probability distribution q [new] in the first generation control.

As the generated probability distribution q [new], an arbitrary probability distribution can be adopted, but here, a normal distribution is adopted. In this case, the generation probability distribution q [new] is defined by an average value and a standard deviation.

The attribute/ID control unit 23 can generate, as the generated probability distribution q [new], a normal distribution in which the weighted addition value of the average value qm of the probability distribution q and the value based on the average value pm of the probability distribution p is the average value qm [new], and the weighted addition value of the standard deviation qv of the probability distribution q and the value based on the standard deviation pv of the probability distribution p is the standard deviation qv [new].

Here, a value based on the average value pm of the probability distribution p is represented by a function f (pm) using the average value pm as an argument, and a value based on the standard deviation pv of the probability distribution p is represented by a function g (pv) using the standard deviation pv as an argument.

In this case, the average value qm [new] of the generation probability distribution q [new] is expressed by an expression qm [new]=α·pm+(1−α)·f (pm), and the standard deviation qv [new] is expressed by an expression qv [new]=α·pv+(1−α)·g (pv). α is a weight for adjusting the ratio of the blend between the probability distribution q and the probability distribution p, and is not limited to the range of 0 to 1, and can be set to an arbitrary value including a negative value. Note that the case of α=0 is substantially equivalent to the case of using only the probability distribution p, and the case of α=1 is equivalent to the case of using only the probability distribution q.

As the function f (pm) that is a value based on the average value pm, for example, f (pm)=X to N(pm, pmstd), f (pm)=pm, or the like can be adopted. X to N(pm, pmstd) represent values sampled on the basis of a normal distribution with an average value of pm and a standard deviation of pmstd. The standard deviation pmstd is a variable for adjusting the randomness of X to N(pm, pmstd), and can be set to an arbitrary value.

As the function g (pv) that is a value based on the standard deviation pv, for example, g (pv)=X to N(pv, pvstd), g (pv)=pv, or the like can be adopted. X to N(pv, pvstd) represent values sampled on the basis of a normal distribution with an average value of pv and a standard deviation of pvstd. The standard deviation pvstd is a variable for adjusting the randomness of X to N(pv, pvstd), and can be set to an arbitrary value.

Hereinafter, f (pm)=X to N(pm, pmstd) is adopted as the function f (pm), and g (pv)=X to N(pv, pvstd) is adopted as the function g (pv).

The weight α and the standard deviations pmstd and pvstd can be set, for example, by qualitative evaluation of the output image.

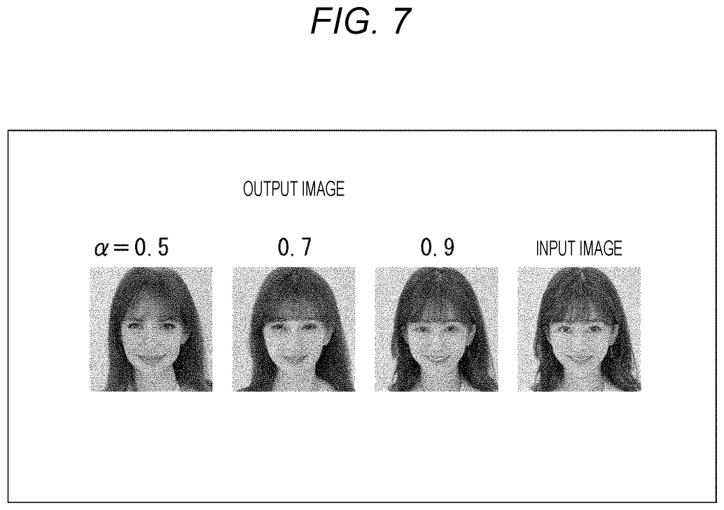

FIG. 7 is a diagram illustrating an example of setting of the weight α by qualitative evaluation.

FIG. 7 illustrates an example of a seed image as an input image and an output image in each case of α=0.5, 0.7, and 0.9.

In the input image in FIG. 7, a Japanese female appears.

In a case of α=0.9, an output image in which a female who is likely to be identified as the same person as the female appearing in the input image appears is generated. Therefore, setting α=0.9 is not appropriate for enlargement of an image of a person (another person) different from the input image.

In a case of α=0.5, the influence of the image in which European and American people included in a large amount in the learning data of the decoder 24 (and the encoder 21) appear becomes strong, and an output image in which the attribute value of race as the attribute is changed from “Japanese” to “European and American” of the input image is generated. Therefore, setting α=0.5 is not appropriate for generating an output image in which a face identified as another person appears while maintaining the attribute of the input image.

In a case of α=0.7, an output image in which a face identified as another person appears is generated while maintaining the attribute value of race as the attribute to “Japanese” of the input image. Therefore, by setting α=0.7, it is possible to efficiently generate an output image in which a face identified as another person appears while maintaining the attribute of the input image.

According to the inventor of the present application, by setting the standard deviations pmstd and pvstd to pmstd=0.35 and pvstd=0.75 by qualitative evaluation, it has been confirmed that an output image in which a face identified by another person appears is efficiently generated while maintaining the attribute of the input image.

Note that the weight α and the standard deviations pmstd and pvstd capable of efficiently generating an output image showing a desired face can vary depending on learning data used for learning by the decoder 24, an input image, an attribute of an input image maintained in the output image, and the like. Therefore, regarding the weight α and the standard deviations pmstd and pvstd, it is desirable to specify and set values effective for obtaining an output image showing a desired face by qualitative evaluation or the like.

The generation of (the feature amount of) the output image using the generation probability distribution q [new], that is, the generation of the output image based on the latent variable z generated on the basis of the generation probability distribution q [new] can be performed on not all the 66 layers of (topdown blocks 41 of) the decoder 24 but some layers.

For example, the output image using the generation probability distribution q [new] can be generated only for some layers of the 66 layers of the decoder 24, for example, only an upper layer, an intermediate layer, a lower layer, and other arbitrarily selected layers. A layer in which the output image is generated using the generation probability distribution q [new] is also referred to as an application layer of the generation probability distribution q [new].

Which some of the 66 layers of the decoder 24 is to be the application layer of the generation probability distribution q [new] can be set, for example, by qualitative evaluation of the output image.

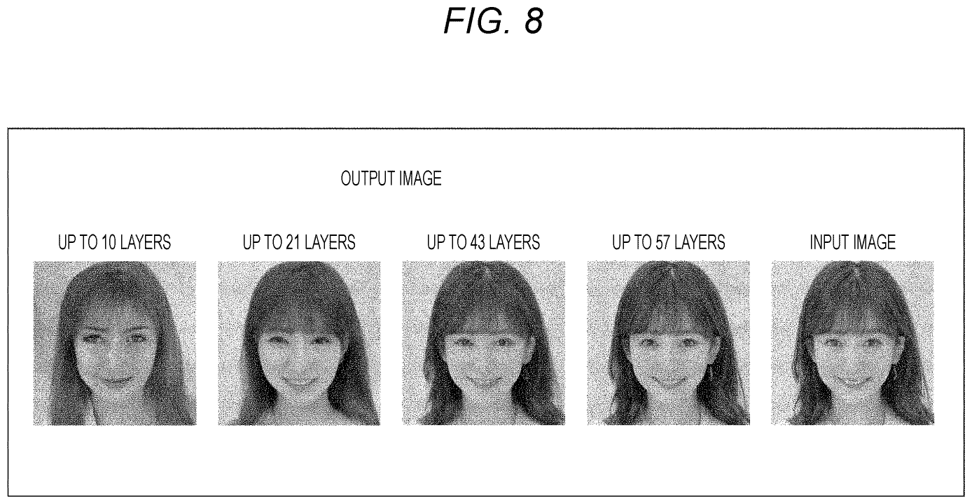

FIG. 8 is a diagram illustrating an example of setting of an application layer of the generation probability distribution q [new] by qualitative evaluation.

FIG. 8 illustrates an example of a seed image as an input image and an output image in a case where application layers of the generation probability distribution q [new] are 10 layers, 21 layers, 43 layers, and 57 layers of the lower layers, respectively.

Note that (the latent variable z generated on the basis of) the probability distribution p is used in the remaining layers other than the application layers of the generation probability distribution q [new] among the 66 layers of the decoder 24.

In the input image in FIG. 8, a Japanese female appears. In a case where 43 layers or 57 layers of the lower layers, or all 66 layers among the 66 layers are set as application layers of the generation probability distribution q [new], an output image is generated in which the influence of the input image (probability distribution q) is large and the randomness (probability distribution p) in the range along the learning data does not appear much. That is, an output image with low diversity in which a female who is likely to be identified as the same person as the female appearing in the input image appears is generated. Therefore, setting many layers among the 66 layers as application layers of the generation probability distribution q [new] is not appropriate for enlargement of an image identified as a person other than the person appearing in the input image.

In a case where the 10 layers of the lower layers among the 66 layers are set as application layers of the generation probability distribution q [new], the influence of the image in which European and American people included in a large amount in the learning data of the decoder 24 appear becomes strong, and an output image in which the attribute value of race as the attribute is changed from “Japanese” to “European and American” of the input image is generated. Therefore, it is not appropriate to set only about 10 layers of the lower layers as the application layers of the generation probability distribution q [new] to generate the output image in which the face identified as another person appears while maintaining the attribute of the input image.

In a case where the 21 layers of the lower layers among the 66 layers are set as application layers of the generation probability distribution q [new], an output image in which a face identified as another person appears is generated while maintaining the attribute value of race as the attribute to “Japanese” of the input image. Therefore, by setting about 21 layers of the lower layer as the application layers of the generation probability distribution q [new], it is possible to efficiently generate the output image in which the face identified as another person appears while maintaining the attribute of the input image.

Note that, in a case where which layer is an application layer of the generation probability distribution q [new], whether or not an output image in which a desired face appears can be efficiently generated can vary depending on learning data used for learning of the decoder 24, an input image, an attribute of an input image maintained in the output image, and the like. Therefore, for the layer to be the application layer of the generation probability distribution q [new], it is desirable to specify and set a layer effective for obtaining an output image in which a desired face appears by qualitative evaluation or the like.

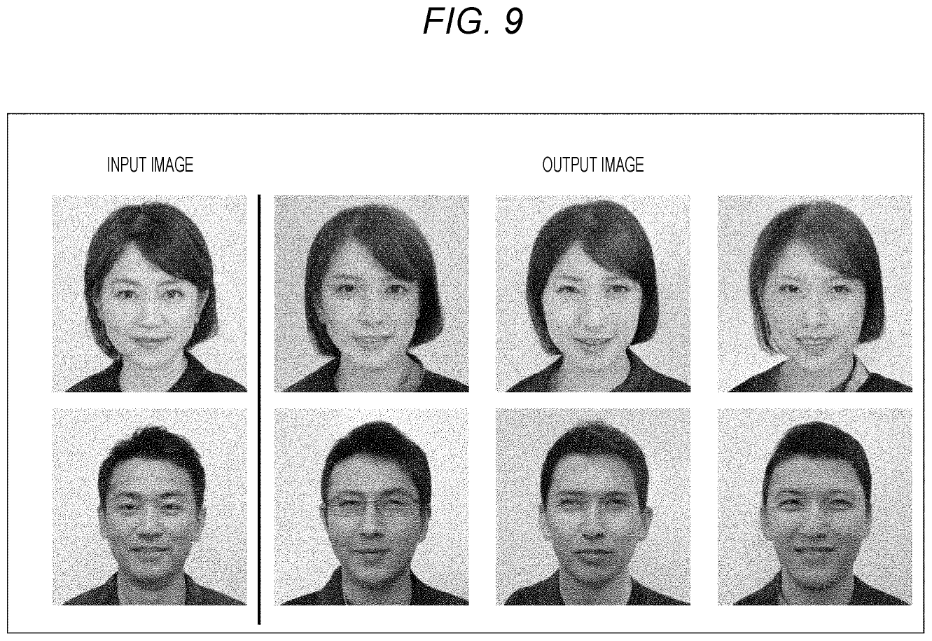

FIG. 9 is a diagram illustrating an example of an output image generated by the decoder 24 on which the first generation control has been performed.

FIG. 9 illustrates an input image (seed image) used for generating the output image together with the output image.

According to FIG. 9, it can be confirmed that the face parts such as the eyes, the nose, and the mouth are different from those of the face appearing in the input image, and an output image in which (the face of) a person other than the person appearing in the input image appears is generated. Furthermore, although Japanese appears in the input image, it can be confirmed that the output image in which the attribute value “Japanese ” of race as the attribute of the input image is maintained is generated. In addition, it is possible to confirm that an output image in which other persons appear is generated.

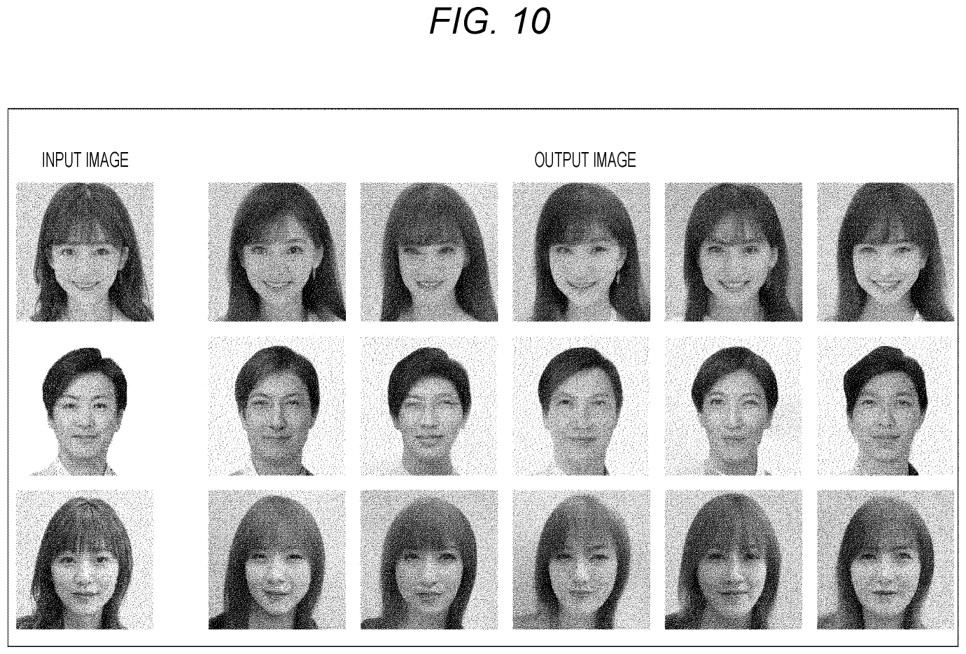

FIG. 10 is a diagram illustrating another example of the output image generated by the decoder 24 on which the first generation control has been performed.

FIG. 10 illustrates an input image (seed image) used for generating the output image together with the output image.

Here, FIG. 9 illustrates an output image in a case where f (pm)=X to N(pm, pmstd) is adopted as the function f (pm) and g (pv)=X to N(pv, pvstd) is adopted as the function g (pv). On the other hand, FIG. 10 illustrates an output image in a case where f (pm)=pm is adopted as the function f (pm) and g (pv)=pv is adopted as the function g (pv).

In the case of FIG. 10, although the diversity of the output image is slightly reduced as compared with the case of FIG. 9, it is possible to confirm that the input image and the output image in which a person other than those in other images appears are generated while maintaining the attribute (Japanese) of the input image.

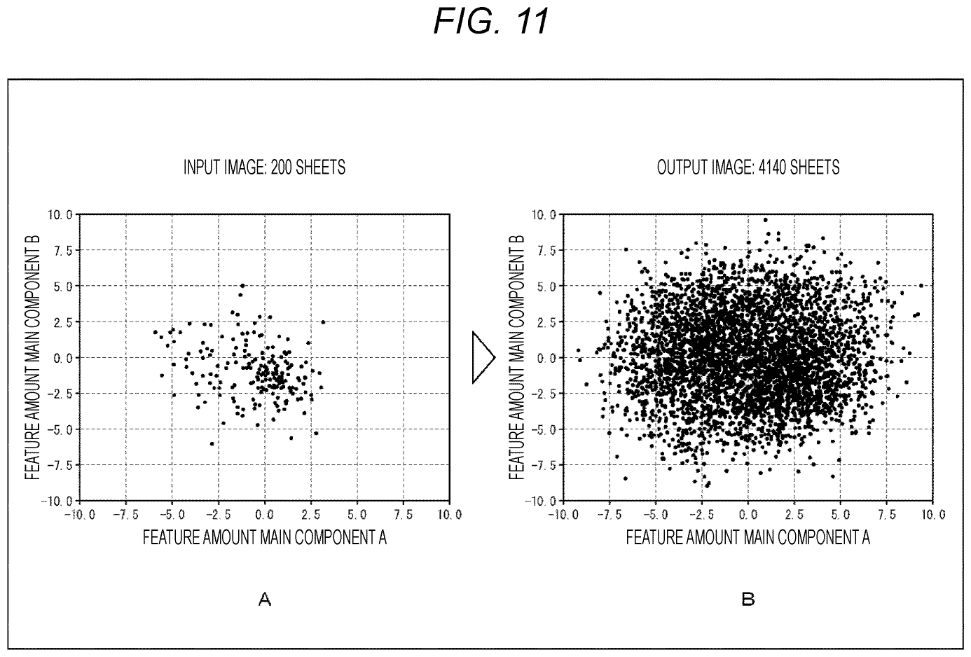

FIG. 11 is a diagram illustrating an example of a distribution of feature amounts of an input image and an output image generated by the first generation control using the input image.

In FIG. 11, the horizontal axis and the vertical axis respectively represent feature amount main components A and B that are a first main component and a second main component of the feature amount obtained by performing the main component analysis on the feature amount of the input image or the output image. The feature amount of the input image or the output image here is not necessarily the same as the feature amount obtained by the encoder 21 or the decoder 24.

A of FIG. 11 illustrates distributions of the feature amount main components A and B of 200 input images (seed images). B of FIG. 11 illustrates distributions of the feature amount main components A and B of 4140 output images generated by the first generation control using 200 input images. It can be confirmed that the output image having no bias in the distribution of the feature amount main components A and B can be enlarged.

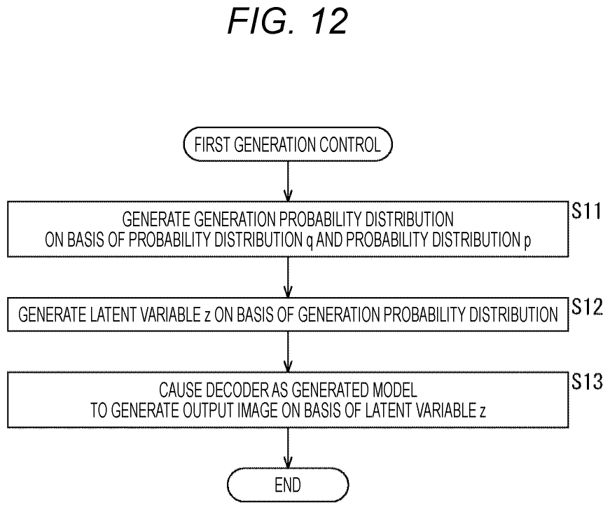

FIG. 12 is a flowchart illustrating an example of processing of the first generation control by the attribute/ID control unit 23.

In step S11, the attribute/ID control unit 23 causes the decoder 24 to generate the probability distribution q on the basis of the feature amount of the input image from the encoder 21 (the feature amount of the input image supplied from the encoder 21 via the scrambling unit 22) and the like. Further, the attribute/ID control unit 23 causes the decoder 24 to generate the probability distribution p. Then, the attribute/ID control unit 23 generates the generated probability distribution q [new] on the basis of the probability distribution q and the probability distribution p, and the processing proceeds from step S11 to step S12.

In step S12, the attribute/ID control unit 23 generates the latent variable z on the basis of the generation probability distribution q [new], and the processing proceeds to step S13. That is, the attribute/ID control unit 23 generates the latent variable z by sampling based on the generation probability distribution q [new] for the application layer of the generation probability distribution q [new].

In step S13, the attribute/ID control unit 23 causes the decoder 24 as a generation model to generate an output image on the basis of the latent variable z. That is, the attribute/ID control unit 23 generates (the feature amount of) the output image on the basis of the latent variable z generated on the basis of the generation probability distribution q [new] for the application layer of the generation probability distribution q [new] among the 66 layers of the decoder 24. In the decoder 24, in a layer other than the application layer of the generation probability distribution q [new], an output image is generated on the basis of the latent variable z generated on the basis of the probability distribution p of the layer.

The attribute/ID control unit 23 performs the processing of steps S11 to S13 for each input image, and repeats the processing of steps S12 and S13 for one input image as many times as necessary. As a result, a necessary number of output images are generated.

### Second Generation Control

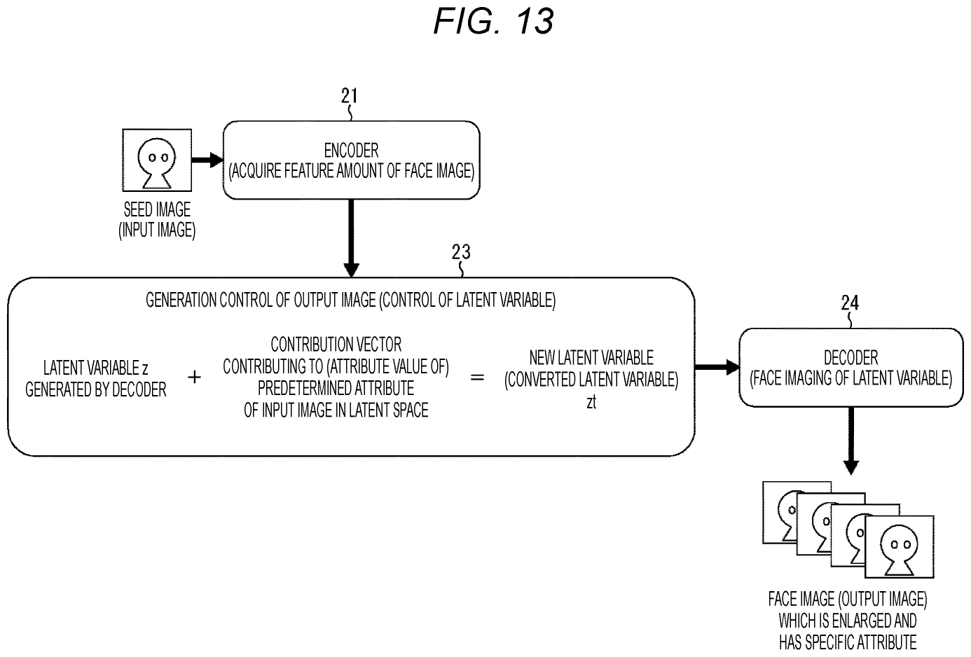

FIG. 13 is a diagram illustrating an outline of the second generation control of the output image.

In the second generation control, the attribute/ID control unit 23 generates a new latent variable zt on the basis of the latent variable z based on the probability distribution generated by the decoder 24 and the contribution vector. That is, the attribute/ID control unit 23 generates the converted latent variable zt as a new latent variable by converting the latent variable z generated by the decoder 24 on the basis of the contribution vector. Then, the attribute/ID control unit 23 causes the decoder 24 to generate an output image (perform face imaging of the converted latent variable zt) on the basis of the converted latent variable zt. The contribution vector is a vector that contributes to ((the change of) the attribute value of) the predetermined attribute of the input image in the latent space. For example, the contribution vector is generated on the basis of the latent variable z generated on the basis of the probability distribution q generated on the basis of the feature amount (activations) of the input image obtained by the encoder 21.

Here, the latent variable z based on the probability distribution generated by the decoder 24 means the latent variable z directly or indirectly generated on the basis of one or both of the probability distributions q and p generated by the decoder 24. Therefore, the latent variable z based on the probability distribution generated by the decoder 24 includes not only a latent variable directly generated on the basis of the probability distribution q or p generated by the decoder 24 but also a latent variable generated on the basis of the generated probability distribution q [new] or the like generated on the basis of the probability distributions q and p. In a case where the latent variable z is generated on the basis of the probability distribution q, the feature amount (activations) of the input image obtained by the encoder 21 is used to generate the probability distribution q. Therefore, the latent variable z based on the probability distribution generated by the decoder 24 can also be referred to as a latent variable generated on the basis of the feature amount of the input image.

As described above, in the second generation control, the output image is generated on the basis of the converted latent variable zt generated by converting the latent variable z on the basis of the contribution vector. As a result, it is possible to efficiently generate a large number of output images in which (the attribute value of) the attribute contributed by the contribution vector of the input image changes from a small number of input images (seed images), and a face that can be identified by the same person and that is difficult to generate only by using the probability distribution q or p appears.

Furthermore, since the output image is generated on the basis of the latent variable z instead of the image-based processing such as editing and composition of the input image, an image showing a natural face can be generated as the output image.

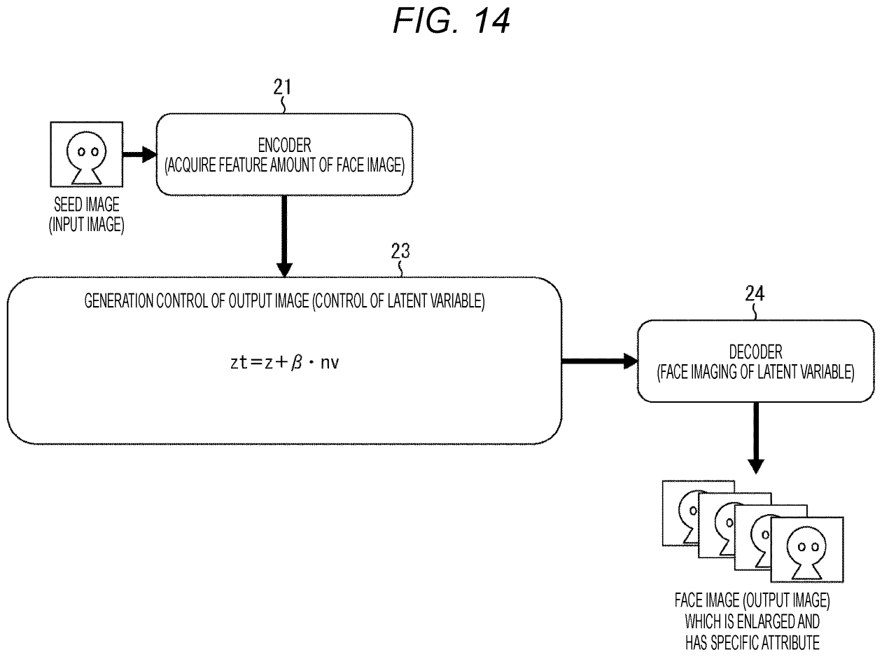

FIG. 14 is a diagram illustrating an example of conversion of the latent variable z in the second generation control.

In the second generation control, the attribute/ID control unit 23 linearly converts the latent variable z into the converted latent variable zt on the basis of the contribution vector β·nv, for example. That is, the attribute/ID control unit 23 linearly converts the latent variable z into the converted latent variable zt according to zt=z+β·nv, for example.

In the contribution vector β·nv, nv represents a (unit) normal vector orthogonal to the division plane that divides the latent space of the latent variable z by the attribute value of the predetermined attribute of the input image. β is a variable representing a fluctuation width of the attribute value of the attribute contributed by the contribution vector β·nv. The attribute value of the attribute (predetermined attribute) contributed by the contribution vector β·nv of the output image is controlled by the value of the variable β.

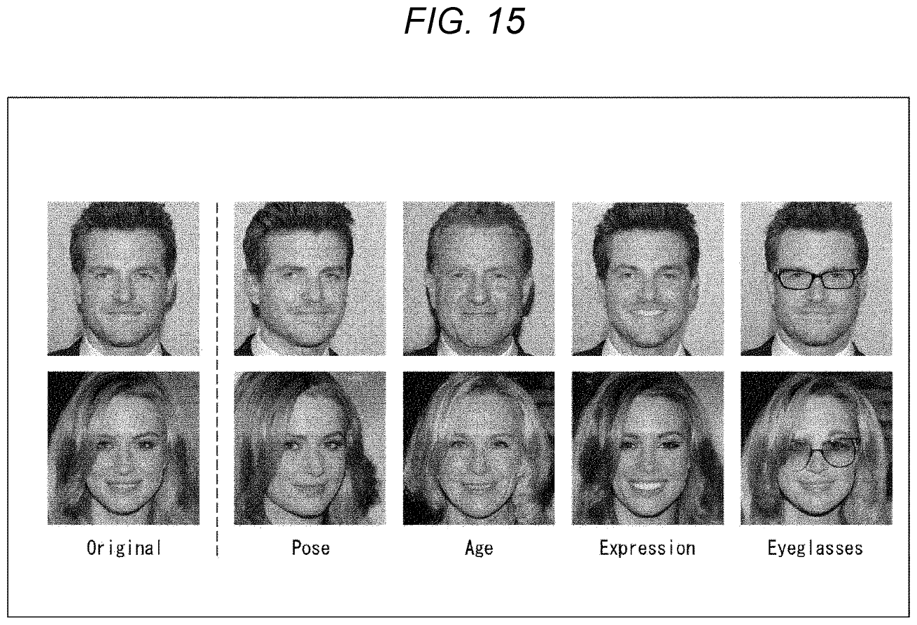

FIG. 15 is a diagram illustrating an example of attributes to which the contribution vector β·nv contributes.

That is, FIG. 15 illustrates an example of the attribute controlled by the contribution vector β·nv.

According to the contribution vector β·nv, for example, attribute values of attributes such as face orientation (Pose), age (apparent age) (Age), expression (Expression), and (presence or absence of) glasses (Eyeglasses) are controlled, and an output image having an attribute value different from that of the input image (Original) can be generated.

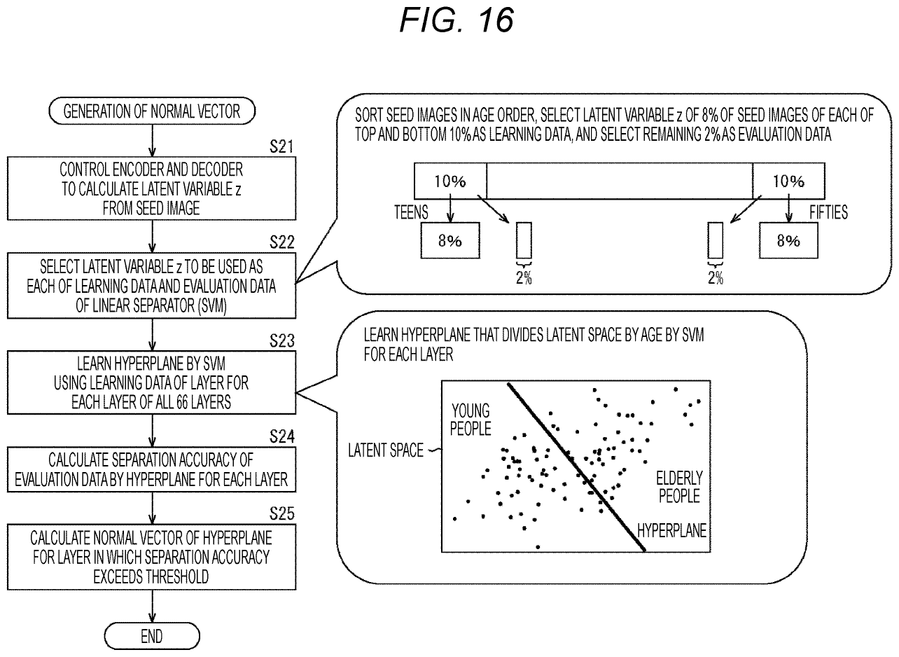

FIG. 16 is a flowchart illustrating an example of processing of generating the normal vector nv by the attribute/ID control unit 23.

In step S21, the attribute/ID control unit 23 controls the encoder 21 and the decoder 24 to generate the latent variable z based on the probability distribution q from the input image (seed image), and the processing proceeds to step S22.

In step S22, the attribute/ID control unit 23 selects the latent variable z to be used as each of the learning data and the evaluation data of the linear separator from the latent variable z of each input image generated in step S21, and the processing proceeds to step S23.

As the linear separator, any other linear separator such as a support vector machine (SVM) can be employed. As the learning data and the evaluation data of the linear separator, it is possible to select the latent variable z of the plurality of upper input images and the plurality of lower input images in a case where the input images are sorted in the order of the predetermined attribute, that is, the attribute value of the attribute (hereinafter, also referred to as an attribute of interest) to be controlled by the second generation control.

For example, in a case where age (apparent age) is adopted as the attribute of interest, the latent variable z of the top 10% of the input images of the input image sorted in age order (ascending order of age), that is, the input image in which a young person appears and the latent variable z of the bottom 10% of the input images, that is, the input image in which an elderly person appears can be selected as the learning data and the evaluation data of the linear separator. Then, for example, the latent variable z of an arbitrary 8% of the input images in the latent variable z of the top 10% of the input images of the input image sorted in the age order, and the latent variable z of an arbitrary 8% of the input images in the latent variable z of the bottom 10% of the input images can be selected as the learning data of the linear separator. Further, the latent variable z of the remaining 2% of the input images in the latent variable z of the top 10% of the input images, and the latent variable z of the input images of the remaining 2% in the latent variable z of the bottom 10% of the input images may be selected as the evaluation data of the linear separator.

In step S23, the attribute/ID control unit 23 learns a hyperplane by the SVM as the linear separator using the latent variable z as the learning data of the layer for each layer of all 66 layers of the decoder 24, and the processing proceeds to step S24. By learning the hyperplane, the hyperplane as the division plane that divides the latent space is calculated by the attribute value of the attribute of interest for each layer of the decoder 24. Here, since the attribute of interest is age, a hyperplane that divides the latent space into a subspace of elderly people and a subspace of young people is calculated.

In step S24, the attribute/ID control unit 23 calculates the separation accuracy of the evaluation data by the hyperplane as the division plane for each layer of the decoder 24, and the processing proceeds to step S25. As the separation accuracy, a ratio of the number of pieces of evaluation data in which the latent variable z as the evaluation data can be separated into the correct one of the subspace of the elderly people and the subspace of the young people can be adopted.

In step S25, the attribute/ID control unit 23 calculates (generates) the (unit) normal vector of the hyperplane as the age control vector for the age control for the layer in which the separation accuracy exceeds the threshold, and the processing ends.

The attribute/ID control unit 23 causes (the feature amount of) the output image based on the converted latent variable zt to be generated only for the layer of the decoder 24 for which the normal vector as the age control vector has been calculated in step S25. For the other layers, (the feature amount of) the output image is generated on the basis of the latent variable z generated by the decoder 24, that is, the latent variable z generated on the basis of the probability distribution q, the probability distribution p, or the generation probability distribution q [new].

The threshold of the separation accuracy used in step S25 can be set, for example, by qualitative evaluation of the output image.

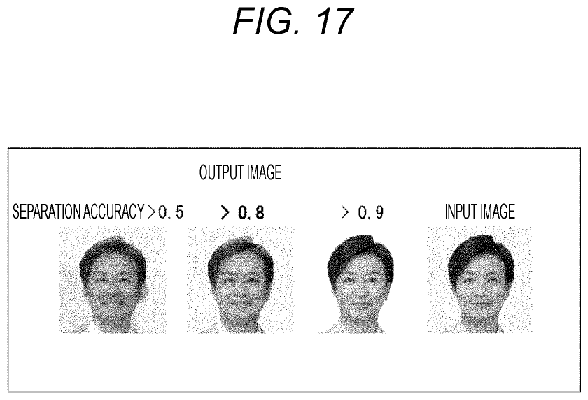

FIG. 17 is a diagram illustrating an example of setting a threshold of separation accuracy by qualitative evaluation.

FIG. 17 illustrates an example of a seed image as an input image and an output image in a case of using the converted latent variable zt obtained by the conversion of the latent variable z based on the normal vector as the age control vector only for the layer with the separation accuracy exceeding the threshold with the separation accuracy thresholds set to 0.5, 0.8, and 0.9, respectively.

In the input image in FIG. 17, a young Japanese male appears.

When (the feature amount of) the output image based on the converted latent variable zt is generated for all the 66 layers of the decoder 24, an image with noise that looks yellowish as a whole is generated as the output image.

Therefore, the generation of the output image based on the converted latent variable zt can be performed not for all of the 66 layers of the decoder 24 but for some layers, for example, only for layers in which the separation accuracy exceeds the threshold.

In a case where the threshold is set to 0.5 and the output image based on the converted latent variable zt is generated only for the layer with the separation accuracy exceeding the threshold, noise that looks yellowish is conspicuous in the output image, similarly to the case where the output image based on the converted latent variable zt is generated for all the 66 layers.

On the other hand, in a case where the threshold is set to 0.8 or more and the output image based on the converted latent variable zt is generated only for the layer with the separation accuracy exceeding the threshold, noise that looks yellowish is reduced and becomes inconspicuous.

Therefore, for example, 0.8 can be adopted as the threshold of the separation accuracy. The threshold of the separation accuracy at which noise becomes inconspicuous in the output image may vary depending on learning data used for learning by the decoder 24 (and the encoder 21), the input image, the attribute of interest, and the like. Therefore, regarding the threshold of the separation accuracy, it is desirable to specify and set a value effective for obtaining an output image in which noise is inconspicuous by qualitative evaluation or the like.

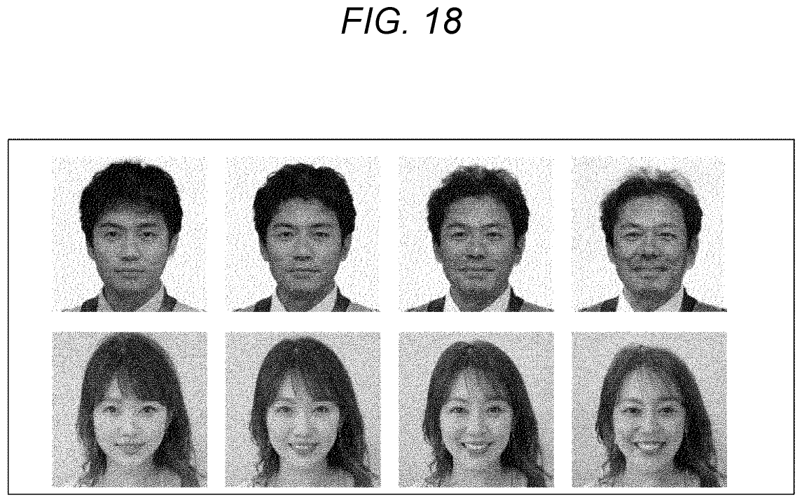

FIG. 18 is a diagram illustrating an example of an output image generated by the decoder 24 on which the second generation control has been performed.

FIG. 18 illustrates an example of an output image in a case where age is adopted as the attribute of interest. In FIG. 18, the image in the first row is an output image obtained by changing the variable β from the input image in which the Japanese male appears, and the image in the second row is an output image obtained by changing the variable β from the input image in which the Japanese female appears.

According to FIG. 18, it is possible to confirm that the output image in which the face in which the age of the person appearing in the input image has widely changed appears is generated regardless of the gender. Furthermore, in the output image, it can be confirmed that the hairstyle, the skin quality, and the like also change with the change in age.

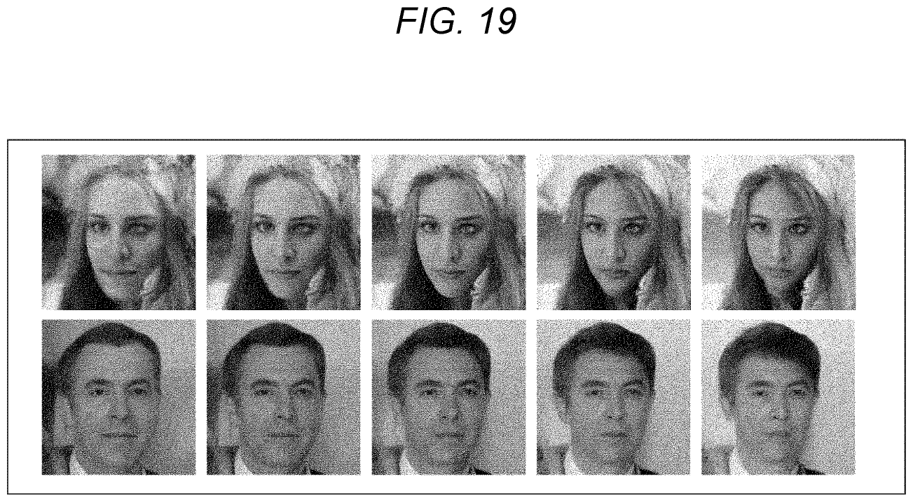

FIG. 19 is a diagram illustrating another example of the output image generated by the decoder 24 on which the second generation control has been performed.

FIG. 19 illustrates an example of an output image in a case where race is adopted as the attribute of interest. In FIG. 19, the image in the first row is an output image obtained by changing the variable β from an input image in which a Western female appears, and the image in the second row is an output image obtained by changing the variable β from an input image in which a Western male appears.

According to FIG. 19, it is possible to confirm that an output image in which a Japanese (or Asian)-like face is captured is generated from a Western face appearing in the input image regardless of gender. Note that, in FIG. 19, the contour and the skin feeling of the face appearing in the output image tend to depend on the input image.

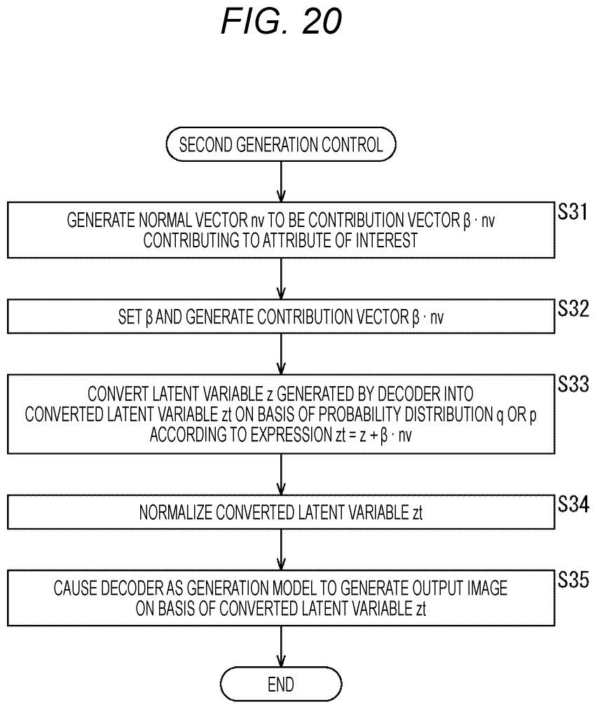

FIG. 20 is a flowchart illustrating an example of processing of the second generation control by the attribute/ID control unit 23.

In step S31, the attribute/ID control unit 23 generates the normal vector nv to be the contribution vector β·nv contributing to the attribute of interest, as described in FIG. 16, and the processing proceeds to step S32. Note that the generation of the normal vector nv can be performed using an arbitrary face image (group) other than the input image in addition to the input image (seed image) as described with reference to FIG. 16. Furthermore, in a case where the normal vector nv has been generated for the attribute of interest in the past, by using the normal vector nv as a normal vector orthogonal to the dividing plane that divides the latent space by the attribute value of the attribute of interest of the input image in the processing of step S32 and subsequent steps, the processing of step S31 can be omitted.

In step S32, the attribute/ID control unit 23 sets the variable β on the basis of the attribute statistical value (for example, distribution of age) or the like of the attribute of interest as the data set requirement. Further, the attribute/ID control unit 23 generates the contribution vector β·nv on the basis of the variable β, and the processing proceeds from step S32 to step S33.

In step S33, the attribute/ID control unit 23 converts the latent variable z generated by the decoder 24 on the basis of the probability distribution q or p or the like into the converted latent variable zt on the basis of the contribution vector β·nv according to the expression zt=z+β·nv, and the processing proceeds to step S34. The conversion of the latent variable z into the converted latent variable zt takes place only for the layer in which the normal vector nv is generated, that is, for the layer for which the separation accuracy exceeds the threshold.

In step S34, the attribute/ID control unit 23 normalizes the converted latent variable zt as necessary, and the processing proceeds to step S35.

In step S35, the attribute/ID control unit 23 causes the decoder 24 as a generation model to generate an output image on the basis of the converted latent variable zt. That is, the attribute/ID control unit 23 generates (the feature amount of) the output image on the basis of the converted latent variable zt for the layer in which the normal vector nv is generated among the 66 layers of the decoder 24. In the decoder 24, in a layer other than the layer in which the normal vector nv is generated, an output image is generated on the basis of the latent variable z generated on the basis of the probability distribution q or p of the layer.

The attribute/ID control unit 23 repeats the processing of steps S32 to S36 for each input image as many times as necessary. As a result, as many output images as necessary are generated in which the attribute values of the attribute of interest have predetermined values or various values.

Here, in a case where the probability distribution q is used as the probability distribution for generating the latent variable z to be converted into the converted latent variable zt in step S33 and the probability distribution for generating the latent variable z of the layer other than the layer in which the normal vector nv is generated in step S35, an output image in which a face which can be identified as the same person as the face appearing in the input image used to generate the probability distribution q and in which the attribute value (for example, age and the like) of the attribute of interest changes according to the variable β appears is generated. In a case where the probability distribution p is used as the probability distribution for generating the latent variable z, an output image in which a face in a range along the learning data of the decoder 24 and having an attribute value of the attribute of interest changed according to the variable β appears is generated.

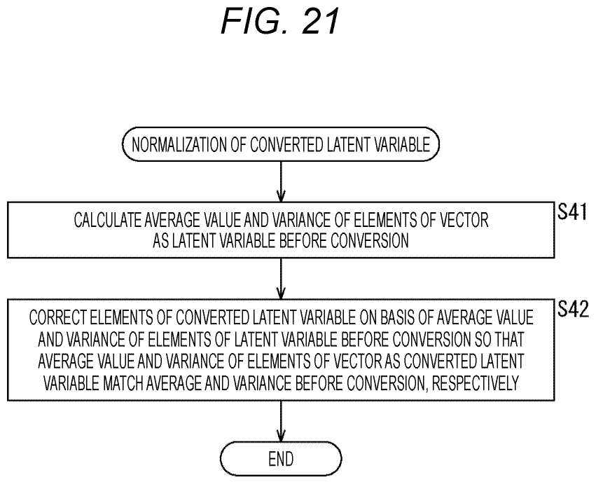

FIG. 21 is a flowchart illustrating an example of the processing of normalizing the converted latent variable zt performed in step S34 in FIG. 20.

The latent variable z is a vector having a plurality of elements, and in step S41, the attribute/ID control unit 23 calculates an average value and a variance of the elements of the vector as the latent variable z before conversion, and the processing proceeds to step S42.

In step S42, the attribute/ID control unit 23 corrects the elements of the converted latent variable zt on the basis of the average value and the variance of the elements of the conversion latent variable z before conversion so that the average value and the variance of the elements of the vector as the converted latent variable zt match the average and the variance before conversion, respectively.

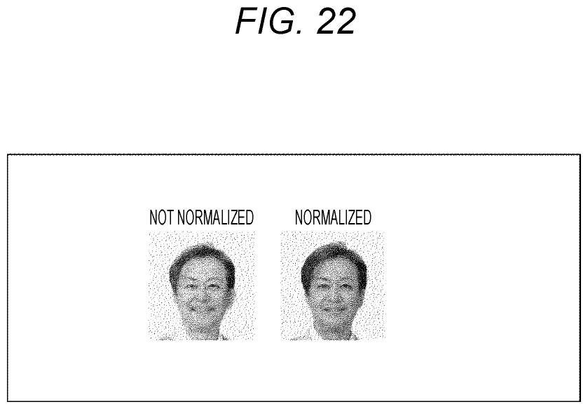

FIG. 22 is a diagram illustrating an example of an output image in a case where normalization of the converted latent variable zt is performed and an example of an output image in a case where the normalization is not performed.

In a case where the converted latent variable zt is used, in particular, for the lower layer among the 66 layers of the decoder 24, when normalization of the converted latent variable zt is not performed, an image having noise that appears to have increased luminance is generated as the output image.

Therefore, for example, in a case where one or both of the lower two layers (the lowermost layer and the second layer from the lowermost layer) become the layer in which the normal vector nv is generated, the converted latent variable zt can be normalized for the layer. By normalizing the converted latent variable zt, an output image in which noise is suppressed can be obtained as illustrated in FIG. 22. Note that the normalization of the converted latent variable zt can be performed not only for the lower two layers but also for the lower three or more layers.

Both the first generation control and the second generation control described above can be performed simultaneously. By simultaneously performing both the first generation control and the second generation control, it is possible to generate a large number of output images identified as other persons and having a wide variety of attribute values of the attribute of interest. For example, in a case where age is adopted as the attribute of interest, it is possible to generate a large number of output images that are identified as other persons and have a wide variety of ages ranging from young people to elderly people.

In a case where both the first generation control and the second generation control are performed simultaneously, as described in the first generation control, for the application layer of the generation probability distribution q [new] among the 66 layers of the decoder 24, (the feature amount of) the output image is generated on the basis of the latent variable z generated on the basis of the generation probability distribution q [new]. For layers other than the application layer of the generation probability distribution q [new], an output image is generated on the basis of the latent variable z generated on the basis of the probability distribution p of the layer. However, for the layer in which the normal vector nv is generated, that is, the layer in which the separation accuracy exceeds the threshold, the latent variable z is converted into the converted latent variable zt as described in the second generation control, and the output image is generated on the basis of the converted latent variable zt.

### UI

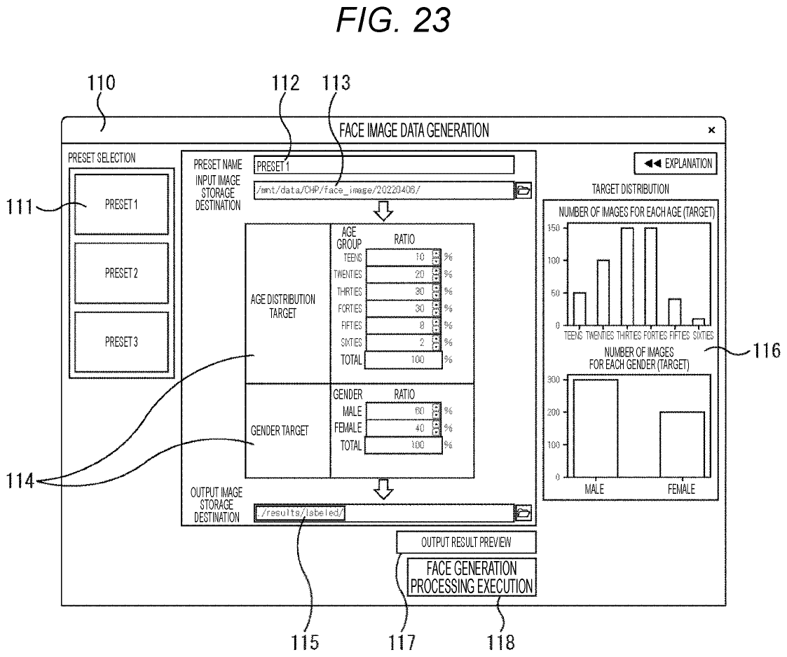

FIG. 23 is a diagram illustrating an example of a UI generated by the UI processing unit 26 in FIG. 1.

Note that the data generation device 11 performs both the first generation control and the second generation control, and age is set as the attribute of interest.

FIG. 23 illustrates a display example of a target distribution input screen 110 as a UI.

The target distribution input screen 110 is a UI for setting a target value of the distribution of the attribute value of each attribute of the output image. The user can input, for example, target values of distributions (age distribution and gender distribution) of the age and gender of the face (person) appearing in the output image (group) as (attribute values of) the attribute of the output image by an operation on the target distribution input screen 110.

The target distribution input screen 110 includes a selection button 111, a preset name field 112, a storage destination field 113, a distribution input field 114, a storage destination field 115, a distribution display field 116, a preview button 117, an execution button 118, and the like.

The selection button 111 is operated to select a preset. Presets are data sets such as (target values of) an age distribution and a gender distribution prepared in advance as defaults, and a seed image as an input image, and in FIG. 23, three presets are prepared according to assumed use cases.

When a preset is selected by operating the selection button 111, a name of the preset is input in the preset name field 112. In addition, the storage destination (path) of the file of the input image as the preset (hereinafter, also referred to as a selection preset) selected by the operation of the selection button 111 is input in the storage destination field 113. Further, the age distribution and the gender distribution as the selection presets are input to the distribution input field 114 as the target values of the age distribution and the gender distribution of the output image.

When the age distribution or the gender distribution as the selection preset input in the distribution input field 114 does not match the age distribution or the gender distribution as the data set requirement of the customer, the user can modify the age distribution or the gender distribution as the selection preset input in the distribution input field 114 to match the age distribution or the gender distribution as the data set requirement. Therefore, the user does not need to input (numerically) the age distribution and the gender distribution as the data set requirement if the age distribution and the gender distribution as the selection presets match the age distribution and the gender distribution as the data set requirement, respectively. Furthermore, in a case where a part of the age distribution or the gender distribution as the selection preset does not match the age distribution or the gender distribution as the data set requirement, it is possible to easily input the age distribution and the gender distribution as the data set requirement only by correcting the non-matching part.

The name of the selection preset is displayed in the preset name field 112.

In the storage destination field 113, the storage destination of the file of the input image is displayed. The user can input the storage destination of the input image prepared separately from the input image as the preset to the storage destination field 113 by operating the storage destination field 113.

In the distribution input field 114, the target values of the age distribution and the gender distribution can be input by operating the distribution input field 114. As described above, in a case where the preset is selected by the operation of the selection button 111, the age distribution or the gender distribution as the selection preset is input to the distribution input field 114 as the target values of the age distribution and the gender distribution.

In FIG. 23, as the target value of the age distribution, a percentage of the number of output images (in which a face appears) of each age group of teens to sixties with respect to the total number of output images is input to the distribution input field 114. The percentage of the number of output images for each age group from the teens to the sixties is adjusted so that the total is 100%.

Furthermore, in FIG. 23, a percentage of the output image in which (the face of) each of males and females (appears) with respect to the total number of the output images is input to the distribution input field 114 as the target value of the gender distribution. In a case where the percentage of the number of output images of one of the males and females is changed according to the operation of the user, the percentage of the number of output images of the other is adjusted so that the sum becomes 100%.

A storage destination of the output image file is displayed in the storage destination field 115. The user can input the storage destination of the output image to the storage destination field 115 by operating the storage destination field 115.

In the distribution display field 116, the target values of the age distribution and the gender distribution input in the distribution input field 114 are displayed in the form of a histogram with the number of output images of each age group and the number of output images of each gender as frequency. The total number of output images can be set, for example, according to an operation of a user. In FIG. 23, the total number of output images is 500.

Note that the target values of the age distribution and the gender distribution can be changed by operating the distribution input field 114 and operating a histogram as the target values of the age distribution and the gender distribution displayed in the distribution display field 116. When the histogram as the target values of the age distribution and the gender distribution displayed in the distribution display field 116 is operated, the percentage of the distribution input field 114 is changed according to the operation.

The preview button 117 is operated in a case where a preview of the output image is displayed.

The execution button 118 is operated in a case where the data generation device 11 generates an output image based on the target values of the age distribution and the gender distribution input in the distribution input field 114 (displayed in the distribution display field 116).

In a case where the preview button 117 or the execution button 118 is operated, in the data generation device 11, the input image stored in the storage destination displayed in the storage destination field 113 is classified into the input image of each of males and females (the input image in which each of males and females appears). Then, the attribute/ID control unit 23 performs the first generation control and the second generation control using the male input image, and the decoder 24 generates various male output images (groups) of various ages based on the target values of the age distribution and the gender distribution. Similarly, the first generation control and the second generation control are performed using the female input image, and various female output images (groups) of various ages based on the target values of the age distribution and the gender distribution are generated. In the generation of the output image, in the second generation control, the latent variable z is converted on the basis of the target value of the age distribution in the distribution input field 114 (distribution display field 116). That is, the variable β is set on the basis of the target value of the age distribution, and the latent variable z is converted into the converted latent variable zt on the basis of the contribution vector β·nv. As a result, an output image having an age distribution as close as possible to the target value of the age distribution is generated.

In the data generation device 11, the annotation unit 25 cleanses the male and female output images generated by the decoder 24 so that the age distribution and the gender distribution of the output image (approximately) match the target values of the age distribution and the gender distribution in the distribution input field 114. Then, in a case where the execution button 118 is operated, the output image obtained as a result of the cleansing is stored in the file of the storage destination displayed in the storage destination field 115.

Note that, in a case where the execution button 118 is operated after the preview button 117 is operated, the output image generated in response to the operation of the preview button 177 can be stored in the file of the storage destination displayed in the storage destination field 115 without newly generating the output image.

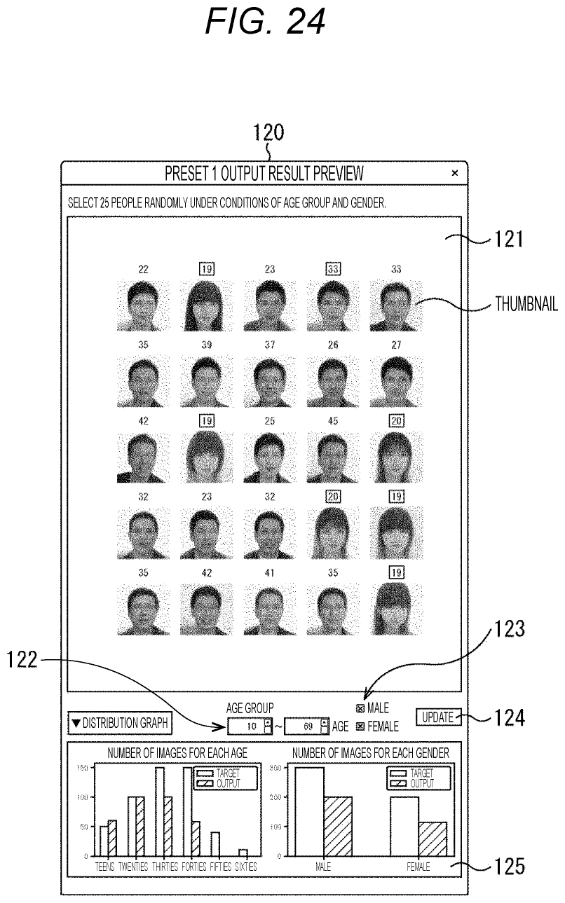

FIG. 24 is a diagram illustrating another example of the UI generated by the UI processing unit 26 in FIG. 1.

FIG. 24 illustrates a display example of a preview screen 120 that displays a preview of an output image as a UI generated in a case where the preview button 117 in FIG. 23 is operated.

The preview screen 120 includes a preview field 121, an age field 122, a gender check box 123, an update button 124, a distribution display field 125, and the like.

In a case where the preview button 117 is operated, the data generation device 11 generates the output image as described above. Furthermore, in the data generation device 11, for example, thumbnails of some randomly selected output images are generated. The thumbnails of some output images generated as described above are displayed in the preview field 121.

A number as a face ID is displayed above the thumbnail. In FIG. 24, only the number as the face ID is displayed above the thumbnail of the male output image, and the number as the face ID is displayed in a rectangular shape above the thumbnail of the female output image. According to the display of the face ID, it is possible to easily grasp the gender of the person appearing in (the thumbnail of) the output image. Note that, in addition, the face IDs can be displayed in different colors, for example, the male face ID is displayed in blue and the female face ID is displayed in red according to the gender of the output image.

In the age field 122, the age range of (the face appearing in) the output image displaying the thumbnail is displayed. The user can change the age displayed in the age field 122 by operating the age field 122. In the preview field 121, the thumbnails of some output images selected from the output images in which faces (people) of ages within the age range displayed in the age field 122 appear are displayed.

The gender check box 123 is operated in a case where the gender of the output image for displaying the thumbnail is selected. The gender check box 123 has a male check box and a female check box. In a case where the male check box is checked, the output image for displaying the thumbnail is selected from the male output image. In a case where the female check box is checked, the output image for displaying the thumbnail is selected from the female output image.

The update button 124 is operated in a case of updating the thumbnail displayed in the preview field 121. In a case where the update button 124 is operated, the output image for displaying the thumbnail in the preview field 121 is reselected, and the thumbnail of the output image is displayed in the preview field 121.

In the distribution display field 125, similarly to the distribution display field 116 in FIG. 23, the target values of the age distribution and the gender distribution (the age distribution and the gender distribution set on the target distribution input screen 110) are displayed in the form of a histogram with the number of output images of each age group and the number of output images of each gender as frequency. Further, in the distribution display field 125, the age distribution and the gender distribution of the output image actually generated by the data generation device 11 are displayed in the form of a similar histogram.

In the distribution display field 125, for the age distribution, the target value (target) of the age distribution and the age distribution (output) of the output image actually generated by the data generation device 11 are displayed in a form of arranging bar graphs representing frequency of the same age group. Similarly, regarding the gender distribution, the target value (target) of the gender distribution and the gender distribution (output) of the output image actually generated by the data generation device 11 are displayed in a form of arranging bar graphs representing the frequency of the same gender. That is, the target value of the number of male output images and the number of male output images actually generated by the data generation device 11 are arranged, and the target value of the number of female output images and the number of female output images actually generated by the data generation device 11 are displayed in an arranged manner.

Note that, in the present embodiment, a face image is adopted as input data and output data of the data generation device 11. However, as the input data and the output data, an image in which a subject other than the face appears, media data other than the image, for example, audio (voice), text (sentence), or the like can be adopted. Furthermore, as the input data and the output data, different media data can be adopted instead of the same media data such as an image. For example, text can be adopted as the input data, and an image having contents represented by the text can be adopted as the output data.

Furthermore, in the present embodiment, (the decoder of) the VDVAE is adopted as the generation model, but an arbitrary generation model other than the VDVAE can be adopted as the generation model. For example, as a generation model to be subjected to the first generation control and the second generation control, a VAE-based generation model other than the VDVAE or a generation model other than VAE can be adopted. For example, as the generation model to be subjected to the first generation control, it is possible to adopt an arbitrary generation model other than the VAE-based generation model, in which a first probability distribution for generating data obtained by restoring input data and a second probability distribution along learning data used for learning of the generation model are obtained as output data.

Here, examples of the technique of editing the composite image include techniques such as interfaceGAN and encoder4editing. InterfaceGAN is described in SHEN, Yujun, et al. Interfacegan: Interpreting the disentangled face representation learned by gans. IEEE transactions on pattern analysis and machine intelligence, 2020. encoder4editing is described in TOV, Omer, et al. Designing an encoder for stylegan image manipulation. ACM Transactions on Graphics (TOG), 2021, 40.4:1-14. Both interfaceGAN and encoder4editing are based on StyleGAN that learns on the premise of image conversion. Therefore, it is difficult to directly apply to VAE based face image generation (face synthesis model) including the VDVAE.

### Description of Computer to Which Present Technology is Applied

Next, the above-described series of processing can be performed by hardware or software. In a case where the series of processing is performed by software, a program constituting the software is installed in a general-purpose computer or the like.

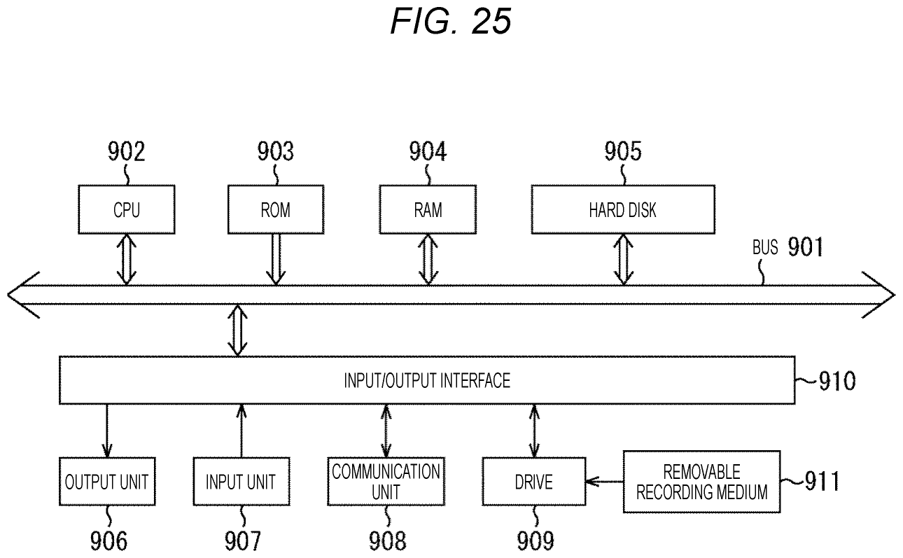

FIG. 25 is a block diagram illustrating a configuration example of an embodiment of a computer on which a program for performing the series of processing described above is installed.

The program can be recorded in advance in a hard disk 905 or a ROM 903 as a recording medium built in the computer.

Alternatively, the program can be stored (recorded) in a removable recording medium 911 driven by a drive 909. Such a removable recording medium 911 can be provided as so-called packaged software. Here, examples of the removable recording medium 911 include, for example, a flexible disk, a compact disc read only memory (CD-ROM), a magneto optical (MO) disk, a digital versatile disc (DVD), a magnetic disk, a semiconductor memory and the like.

Note that the program can be installed in the computer from the removable recording medium 911 as described above, or can be downloaded to the computer via a communication network or a broadcast network and installed in the built-in hard disk 905. That is, for example, the program can be wirelessly transferred from a download site to the computer through an artificial satellite for digital satellite broadcasting, or can be transferred by wire to the computer through a network such as a local area network (LAN) and the Internet.

The computer incorporates a central processing unit (CPU) 902, and an input/output interface 910 is connected to the CPU 902 via a bus 901.

When a command is input by a user operating an input unit 907 or the like via the input/output interface 910, the CPU 902 executes a program stored in a read only memory (ROM) 903 according to the command. Alternatively, the CPU 902 loads the program stored in the hard disk 905 into a random access memory (RAM) 904 and executes the program.

Therefore, the CPU 902 performs processing according to the above-described flowchart or processing to be performed according to the above configuration described with the block diagram. Then, the CPU 902 outputs the processing result from an output unit 906, transmits the processing result from a communication unit 908, or records the processing result in the hard disk 905 via the input/output interface 910, for example, as necessary.

Note that, the input unit 907 includes a keyboard, a mouse, a microphone, and the like. Furthermore, the output unit 906 includes a liquid crystal display (LCD), a speaker, and the like.

Here, in the present specification, the processing performed by the computer according to a program is not necessarily performed in time series order illustrated in the flowchart. That is, the processing performed by the computer according to the program also includes processing executed in parallel or individually (for example, parallel processing or processing by an object).

Furthermore, the program may correspond to processing to be performed by one computer (processor) or processing to be performed in a distributed manner by a plurality of computers. Moreover, the program may be transferred to a distant computer to be executed.

Moreover, in the present description, a system means a set of a plurality of configuration elements (devices, modules (parts), and the like), and it does not matter whether or not all the configuration elements are in the same housing. Therefore, a plurality of apparatuses housed in separate housings and connected to each other via a network and one apparatus in which a plurality of modules is housed in one housing are both systems.

Note that embodiments of the present technology are not limited to the above-described embodiments, and various changes can be made without departing from the gist of the present technology.

For example, the present technology can have a configuration of cloud computing in which one function is shared and processed in cooperation by a plurality of devices via a network.

Furthermore, each step described in the flowchart described above can be performed by one device or can be performed by a plurality of devices in a shared manner.

Moreover, in a case where one step includes a plurality of pieces of processing, the plurality of pieces of processing included in the one step can be performed by a one device or performed by a plurality of devices in a shared manner.

Furthermore, the effects described in the present specification are merely examples and are not restrictive, and some other effects may be achieved.

Note that the present technology can also have the following configurations.

### 1

An information processing apparatus including
a control unit that:
generates a generation probability distribution used for generation of a latent variable for generating output data in a generation model of the output data that outputs the output data with respect to an input of input data, as the output data, on the basis of
a first probability distribution for generating data obtained by restoring the input data, and
a second probability distribution along learning data used for learning of the generation model;
generates the latent variable on the basis of the generation probability distribution; and
causes the generation model to generate the output data on the basis of the latent variable.

### 2

The information processing apparatus according to <1>, in which the generation probability distribution, and the first probability distribution and the second probability distribution are normal distributions.

### 3

The information processing apparatus according to <2>, in which
the generation probability distribution
is a normal distribution in which
a weighted addition value of an average value of the first probability distribution and a value based on an average value of the second probability distribution is set as an average value, and
a weighted addition value of a standard deviation of the first probability distribution and a value based on a standard deviation of the second probability distribution is set as a standard deviation.

### 4

The information processing apparatus according to <3>, in which
the generation probability distribution
is a normal distribution in which
a weighted addition value of an average value of the first probability distribution and a value sampled on the basis of a normal distribution having an average value of the second probability distribution as an average value is set as an average value, and
a weighted addition value of a standard deviation of the first probability distribution and a value sampled on the basis of a normal distribution having a standard deviation of the second probability distribution as an average value is set as a standard deviation.

### 5

The information processing apparatus according to <3>, in which
the generation probability distribution
is a normal distribution in which
a weighted addition value of an average value of the first probability distribution and an average value of the second probability distribution is set as an average value, and
a weighted addition value of a standard deviation of the first probability distribution and a standard deviation of the second probability distribution is set as a standard deviation.

### 6

The information processing apparatus according to any one of <1> to <5>, in which the generation model is a decoder of a variational autoencoder (VAE).

### 7

The information processing apparatus according to <6>, in which the generation model is a decoder of very deep VAE (VDVAE) in which an encoder and the decoder are configured by a plurality of layers.

### 8

The information processing apparatus according to <7>, in which
the control unit generates the latent variable for some layers of the plurality of layers of the decoder on the basis of the generation probability distribution, and generates the latent variable for remaining layers on the basis of the second probability distribution.

### 9

The information processing apparatus according to <8>, in which
the control unit generates the latent variable on the basis of the generation probability distribution for some layers in a lower part of the plurality of layers of the decoder.

### 10

The information processing apparatus according to any one of <1> to <9>, in which the input data and the output data are images.

### 11

The information processing apparatus according to <10>, in which
the image is a face image in which a face appears.

### 12

A data generation method including:
generating a generation probability distribution used for generation of a latent variable for generating output data in a generation model of the output data that outputs the output data with respect to an input of input data, as the output data, on the basis of
a first probability distribution for generating data obtained by restoring the input data, and
a second probability distribution along learning data used for learning of the generation model;
generating the latent variable on the basis of the generation probability distribution; and
generating, by the generation model, the output data on the basis of the latent variable.

### 13

A program for causing a computer to function as
a control unit that:
generates a generation probability distribution used for generation of a latent variable for generating output data in a generation model of the output data that outputs the output data with respect to an input of input data, as the output data, on the basis of
a first probability distribution for generating data obtained by restoring the input data, and
a second probability distribution along learning data used for learning of the generation model;
generates the latent variable on the basis of the generation probability distribution; and
causes the generation model to generate the output data on the basis of the latent variable.

### REFERENCE SIGNS LIST

11 Data generation device
21 Encoder
22 Scrambling unit
23 Attribute/ID control unit
24 Decoder
25 Annotation unit
26 UI processing unit
31 Residual block
32 Pooling layer
41 Top-down block
42 Unpooling layer
51 to 54 Convolution layer
55 Addition unit
61 to 70 Convolution layer
71, 72 Addition unit
73 Residual block
110 Target distribution input screen
111 Selection button
112 Preset name field
113 Storage destination field
114 Distribution input field
115 Storage destination field
116 Distribution display field
117 Preview button
118 Execution button
120 Preview screen
121 Preview field
122 Age field
123 Gender check box
124 Update button
125 Distribution display field
901 Bus
902 CPU
903 ROM
904 RAM
905 Hard disk
906 Output unit
907 Input unit
908 Communication unit
909 Drive
910 Input/output interface
911 Removable recording medium

1. An information processing apparatus comprising a control unit that:
generates a generation probability distribution used for generation of a latent variable for generating output data in a generation model of the output data that outputs the output data with respect to an input of input data, as the output data, on a basis of
a first probability distribution for generating data obtained by restoring the input data, and
a second probability distribution along learning data used for learning of the generation model;
generates the latent variable on a basis of the generation probability distribution; and
causes the generation model to generate the output data on a basis of the latent variable.

2. The information processing apparatus according to claim 1, wherein
the generation probability distribution, and the first probability distribution and the second probability distribution are normal distributions.

3. The information processing apparatus according to claim 2, wherein
the generation probability distribution
is a normal distribution in which
a weighted addition value of an average value of the first probability distribution and a value based on an average value of the second probability distribution is set as an average value, and
a weighted addition value of a standard deviation of the first probability distribution and a value based on a standard deviation of the second probability distribution is set as a standard deviation.

4. The information processing apparatus according to claim 3, wherein
the generation probability distribution
is a normal distribution in which
a weighted addition value of an average value of the first probability distribution and a value sampled on a basis of a normal distribution having an average value of the second probability distribution as an average value is set as an average value, and
a weighted addition value of a standard deviation of the first probability distribution and a value sampled on a basis of a normal distribution having a standard deviation of the second probability distribution as an average value is set as a standard deviation.

5. The information processing apparatus according to claim 3, wherein
the generation probability distribution
is a normal distribution in which
a weighted addition value of an average value of the first probability distribution and an average value of the second probability distribution is set as an average value, and
a weighted addition value of a standard deviation of the first probability distribution and a standard deviation of the second probability distribution is set as a standard deviation.

6. The information processing apparatus according to claim 1, wherein
the generation model is a decoder of a variational autoencoder (VAE).

7. The information processing apparatus according to claim 6, wherein
the generation model is a decoder of very deep VAE (VDVAE) in which an encoder and the decoder are configured by a plurality of layers.

8. The information processing apparatus according to claim 7, wherein
the control unit generates the latent variable for some layers of the plurality of layers of the decoder on a basis of the generation probability distribution, and generates the latent variable for remaining layers on a basis of the second probability distribution.

9. The information processing apparatus according to claim 8, wherein
the control unit generates the latent variable on a basis of the generation probability distribution for some layers in a lower part of the plurality of layers of the decoder.

10. The information processing apparatus according to claim 1, wherein
the input data and the output data are images.

11. The information processing apparatus according to claim 10, wherein
the image is a face image in which a face appears.

12. A data generation method comprising:
generating a generation probability distribution used for generation of a latent variable for generating output data in a generation model of the output data that outputs the output data with respect to an input of input data, as the output data, on a basis of
a first probability distribution for generating data obtained by restoring the input data, and
a second probability distribution along learning data used for learning of the generation model;
generating the latent variable on a basis of the generation probability distribution; and
generating, by the generation model, the output data on a basis of the latent variable.

13. A program for causing a computer to function as a control unit that:
generates a generation probability distribution used for generation of a latent variable for generating output data in a generation model of the output data that outputs the output data with respect to an input of input data, as the output data, on a basis of
a first probability distribution for generating data obtained by restoring the input data, and
a second probability distribution along learning data used for learning of the generation model;
generates the latent variable on a basis of the generation probability distribution; and
causes the generation model to generate the output data on a basis of the latent variable.
